(19) United States
(12) Patent Application Publication
(10) Pub. No.: US 2001/0015979 A1
(43) Pub. Date: Aug. 23, 2001

(54) Ring transmission system and method of controlling squelch in ring transmission system

(75) Inventors: Kazuhiko Hata, Kawasaki (JP); Tomoyuki Yamamoto, Kawasaki (JP)

Correspondence Address: HELFGOTT & KARAS, P.C., 60th FLOOR, EMPIRE STATE BUILDING, NEW YORK, NY, 10118, US

(73) Assignee: FUJITSU LIMITED

(21) Appl. No.: 09/746,434

(22) Filed: Dec. 21, 2000

(30) Foreign Application Priority Data
Dec. 24, 1999 (JP) 11-367451

(51) Int. Cl. H04L 12/56

(52) U.S. Cl. 370/403; 370/406

(57) ABSTRACT

A ring transmission system includes a plurality of nodes that are connected to each other to form a ring by a bi-directional line switched ring (BLSR) method. The ring transmission system further includes a channel-adding node that adds a channel to the ring, and transmits a node identification (ID) of the channel-adding node to other nodes on the ring when creating a squelch table; and a channel-dropping node that drops the channel from the ring, and stores the node ID of the channel-adding node received directly from the channel-adding node or through the other nodes on the ring in the squelch table of the channel-dropping node, wherein the channel-dropping node detects a failed channel through which a signal does not reach the channel-dropping node among one or more channels dropped at the channel-dropping node based on information about a location of failure on the ring, a ring-topology table managed by the channel-dropping node, and the node ID of the channel-adding node stored in the squelch table of the channel-dropping node when the failure occurs on the ring, and inserts a squelch into the failed channel. By having the above-described structure, the ring transmission system is capable of executing squelch control on upper-level and lower-level channels such as STS1 and VT1 channels efficiently with a simple structure and control.

### BACKGROUND OF THE INVENTION

1. Field of the Invention

The present invention relates to a ring transmission system and a method of controlling a squelch In the ring transmission system. More particularly, the present invention relates to a ring transmission system in which a plurality of nodes are connected to each other by a BLSR (Bi-directional Line-Switched Ring) method and a method of controlling a squelch In the ring transmission system.

2. Description of the Related Art

Recent optical transmission systems have been moving forward to apply mainly the BLSR method to their system structures because of the method's capability of increasing a rate of effective line usage. In such circumstances, existing squelching methods support a 50 Mbps-level STS1 access BLSR configuration, thereby preventing misconnection of an STS1-level line. However, in future, increase in the rate of effective line usage should be achieved by taking subscriber services into consideration, and thus squelching methods should desirably support a 1.5 Mbps-level VT1 access BLSR configuration as part of their achievements.

Japanese Laid-open Patent Application No. 9-93278 discloses a ring transmission system capable of supporting an STS1-level line by applying the BLSR configuration thereto and a squelching method of the system. A description will now be given of such a ring transmission system.

FIGS. 1A, 1B and 1C are diagrams showing a conventional method of constructing a ring topology. FIG. 1A shows a system in which four nodes A, B, C, and D are connected by a ring transmission path RL. Identification (ID) numbers 15, 3, 7 and 8 are initially provided to the nodes A, B, C and D respectively. Subsequently, an instruction to construct a ring topology (a ring map) is given as shown in FIG. 1B. At a step S1, the node A sets the number of inserted nodes to “1”, adds the ID number 15 to the first area of a node ID part in a ring-topology frame, and then transmits the ring-topology frame, for instance, to the node B in a clockwise direction on the ring transmission path RL. At a step S2, the node B sets the number of inserted nodes to “2”, adds the ID number 3 next to the ID number 15 of the node A in the ring-topology frame, and transmits the ring-topology frame to the node C. At a step S3, the node C sets the number of inserted nodes to “3”, adds the ID number 7 next to the ID number 3 in the ring-topology frame, and transmits the ring-topology frame to the node D. At a step S4, the node D sets the number of inserted nodes to “4”, adds the ID number 8 next to the ID number 7 in the ring-topology frame, and transmits the ring-topology frame to the node A.

The node A recognizes that the ring-topology frame has passed through all the nodes on a ring by detecting the ID number 15 of the node A at a head of the node ID part of the ring-topology frame received from the node D. Subsequently, the node A adds an END flag at a tail of the node ID part in the ring-topology frame, and notifies the node B of a completed ring-topology frame by transmitting the ring-topology frame to the node B at a step S5. Similarly, at a step S6, the node B transmits the ring-topology frame to the node C after receiving the ring-topology frame from the node A. At a step S7, the node C transmits the ring-topology frame to the node D after receiving the ring-topology frame from the node C. In addition, each node that has received the ring-topology frame from an adjacent node constructs a ring-topology table by placing its node ID number at the head of the node ID part. For example, the ring-topology table at the node A includes a ring topology “15, 3, 7, 8”. At the node B, the ring-topology table includes a ring topology “3, 7, 8, 15”. At the node D, the ring-topology table includes a-ring topology “8, 15, 3, 7”. Because of such ring-topology construction, each node can easily transmits its own ID number and a destination ID number in K1 and K2 bytes by use of an APS (Automatic Protection Switch) protocol.

Additionally, a squelch table is created based on the above-described ring topology by following steps shown in FIGS. 2A, 2B, 2C and 2D FIGS. 2A, 2B, 2C and 2D are diagrams showing a conventional method of constructing a squelch table. In the figures, each of the nodes A, B, C and D Includes a squelch table, and originally stores node ID numbers in the squelch table. However, node names are stored instead of the node ID numbers in the squelch table shown in the figures for a description purpose. In a case in which signals are exchanged between the nodes C and D through the nodes A and B as shown in FIG. 2A, the node C initially inserts a node ID “C” and a sign “*” indicating that the other party (terminal) is unknown, to a part corresponding to a communication channel shown in FIG. 2A of the squelch table, and notifies the node B that the node C is a terminal at a step S11. Additionally, at the step S11, the node D inserts a node ID “D” and a sign “Δ” indicating that the other party (terminal) is unknown, to a part corresponding to the communication channel shown in FIG. 2A of the squelch table, and notifies the node A that the node D is a terminal.

Subsequently, at a step S12 shown In FIG. 2B, the node B is notified from the node D through the node A that the node D is the terminal on a node-A side. Additionally, the node A is notified from the node C through the node B that the node C is the terminal on a node-B side. At a step S13 shown in FIG. 2C, the node B notifies the node C that the node D is the terminal exchanging signals with the node C. Additionally, the node A notifies the node D that the node C is the terminal exchanging the signals with the node D. Consequently, the node C sets its own node ID “C” and the other party's node ID “D” in the squelch table of the node C. On the other hand, the node D sets its own node ID “D” and the other party's node ID “C” in the squelch table of the node D.

Following the step S13, the node C notifies the node B that the sign “*” is the node ID “D” at a step S14 shown in FIG. 2D based on a completed squelch table of the node C. Similarly, the node D notifies the node A that the sign “Δ” is the node ID “C” based on a completed squelch table of the node D. Additionally, at a step S15, the node B notifies the node A that the sign is the node ID “D”. The node A notifies the node B that the sign “Δ” is the node ID “C”. Accordingly, a squelch table corresponding to the communication channel between the nodes C and D is created in the nodes A and B.

FIGS. 3A and 3B are diagrams showing a conventional method of controlling an STS1 access BLSR squelch. In a BLSR configuration, a single STSch1 (STS channel 1) is simultaneously usable among different groups of nodes, and thus a BLSR system has an advantage of increasing overall line capacity on a ring. For instance, a BLSR system shown in FIG. 3A includes four nodes 1, 2, 3 and 4 on a ring. The node 1 transmits a signal to the node 3 through the STSch1 in an east to west (E→W) direction, and to the node 4 through the STSch1 in a west to east (W→E) direction. The node 3 transmits a signal to the node 4 through the STSch1 in the E→W direction.

FIG. 3B shows two communication lines, a currently used (working) line WK and a spare (protection) line PT. If a transmission-path failure occurs on the currently used line WK between the nodes 2 and 3, the transmission-path failure is aided by following the APS protocol. The STSch1 as the currently used line WK is looped back (bridged) to an STSch25 (STS channel 25) as the spare line PT at the node 2. Additionally, the STSch25 is switched to the STSch1 at the node 3. Accordingly, a transmission path between the nodes 1 and 3 can be continuously connected.

To be concrete, when the transmission-path failure occurs between the nodes 2 and 3 on the currently used line WK, the node 3 detects an alarm signal, and becomes a switching node. Subsequently, the node 3 transmits a request signal SF-RING (Signal Failure Ring) indicating the transmission-path failure to the node 2 through short and long paths. The nodes 1 and 4 receive the request signal from the node 3 through the long path, and check a destination of the request signal When detecting that the destination of the request signal is the node 2, the nodes 1 and 4 change their operating states to a “full pass through” state in which the nodes 1 and 4 make the K1 byte, the K2 byte and the spare line PT (protection channel PT) pass through the nodes 1 and 4. Additionally, the node 2 becomes a switching node after receiving the request signal from the node 3 through the short path. The node 2 then transmits a reverse request signal RR-RING (Reverse Request Ring) through the short pass and the request signal SF-RING through the long path.

In a case in which a transmission-path failure occurs on a ring, nodes on the ring execute bridging and switching simultaneously after receiving the request signal SF-RING through the long path. Bridging indicates a situation in which a node outputs the same traffic to a currently used channel and a protection channel. Switching indicates a situation in which a node selects traffic from a protection channel. Thus, the node 2 creates a bridge therein for passing a signal transmitted from the node 1 to the node 3 through the currently used line WK to the spare line PT. The node 3 switches back a line used for transmitting the signal from the spare line PT to the currently used line WK. As described above, the transmission path between the nodes 1 and 3 is continuously connected.

FIG. 4 is a diagram showing another conventional method of controlling an STS1 access BLSR squelch. When communicating between the nodes 1 and 3, between the nodes 1 and 4, and between the nodes 3 and 4 through the STSch1, a squelch table corresponding to the STSch1 of each node stores node ID numbers of a transmission node S (Source) adding a signal and of a reception node D (Destination) dropping the signal for every direction of transmitting the signal. For example, the squelch table of the node 1 stores a node ID number “1” for the transmission node S and a node ID number “3” for the reception node D, for the E→W direction (a node-2 direction). Additionally, the squelch table of the node 1 stores the node ID number “1” for the transmission node S and a node ID number “4” for the reception node D for the W→E direction (a node-4 direction). Consequently, the squelch table of the node 1 stores information “3, 1, 1, 4”. In other words, the squelch table of the node 1 stores node ID numbers by arranging an order of the transmission node S and the reception node D in the squelch table following the direction of transmitting the signal.

If a transmission-path failure occurs as shown in FIG. 4 between the nodes 2 and 3, and between the nodes 3 and 4 on the ring, the node 3 becomes isolated from other nodes on the ring. Under such circumstances, a signal supposed to be transmitted from the node 1 to the node 3 is actually transmitted from the node 1 to the node 4 in a case of bridging the currently used line STSch1 to the spare line STSch25 at the node 2, and of switching the spare line STSch25 to the currently used line STSch1 at the node 4. As described above, the transmission path between the nodes 1 and 3 is apparently misconnected. In order to solve the above-described problem, the nodes 2 and 4 respectively detect the transmission-path failure between the nodes 2 and 3, and between the nodes 3 and 4, and thus become switching nodes. Subsequently, the request signal SF-RING may be transmitted to the node 3 based on squelch tables of the nodes 2 and 4 as the switching nodes. However, the node 3 cannot receive the request signal since the node 3 is disconnected from the other nodes on the ring. On the other hand, misconnection of the transmission path between the nodes 1 and 3 can be avoided by inserting a squelch SQ (P-AIS: Pass Alarm Indication Signal) to the spare line STSch25 bridged from the currently used line STSch1 at the node 2, and to the currently used line STSch1 that is switched from the spare line STSch25 and is located between the nodes 3 and 4.

FIGS. 5A and 5B are diagrams showing a problem in the conventional method of controlling the STS1 access BLSR squelch. A ring transmission system supports a 50 Mbps-level STS1 access BLSR configuration, and prevents the misconnection of an STS1-level line by the above-described conventional method. However, hereafter, increase in a rate of effective usage of the line should be achieved considering subscriber services. As a part of such an achievement, the ring transmission system needs to support a 1.5 Mbps-level VT1 access BLSR configuration. In a ring transmission system shown in FIG. 5A, a VT1-level channel VT diverges at a node 2 from the STSch1 placed between nodes 1 and 3. In a case in which a transmission-path failure occurs between the nodes 2 and 3, and between nodes 4 and 5 on the STSch1 as shown in FIG. 5B, signal transmission on the VT1-level channel is originally not affected by the transmission-path failure on the STSch1 since the VT1-level channel VT is not isolated from nodes necessary for transmitting a signal to the VT1-level channel VT shown in FIG. 5B. However, if only the above described squelch table corresponding to the STS1 is provided in the ring transmission system for supporting a VT1-level access, the signal transmission on the VT1-level channel VT is canceled by the above-described squelch SQ operated at an STS1 level. Consequently, such a situation gives unnecessary discontinuation of the subscriber services to a user.

Accordingly, a VT1-level squelch must be constructed for solving the above-described problem of the ring transmission system. Since one STS1 level channel includes twenty-eight VT1-level channels, by a simple calculation, construction of a VT1-level squelch table must be repeated for twenty eight times by following the above-described method of constructing an STS1-level squelch table. In addition, since switching nodes to which the squelch SQ is inserted by the conventional method of controlling the STS1 access BLSR squelch are the nodes 2 and 5 in the ring transmission system shown in FIG. 5B, each of the switching nodes 2 and 5 needs twenty eight times more processing load than a switching node that inserts only a single squelch to the STS1 channel, and thus possibility of causing a system performance problem is very high.

### SUMMARY OF THE INVENTION

Accordingly, it is a general object of the present invention to provide a ring transmission system and a method of controlling a squelch in the ring transmission system, which obviate one or more of the problems of the related art. More particularly, the present invention relates to a ring transmission system capable of executing squelch control on upper-level and lower-level channels such as STS1 and VT1 channels efficiently with a simple structure and control, and a method of controlling a squelch in the ring transmission system.

The above-described object of the present invention is achieved by a ring transmission system In which a plurality of nodes are connected to each other to form a ring by a bi-directional line switched ring (BLSR) method, the ring transmission system including a channel-adding node that adds a channel to the ring, and transmits a node identification (ID) of the channel-adding node to other nodes on the ring when creating a squelch table; and a channel-dropping node that drops the channel from the ring, and stores the node ID of the channel-adding node received directly from the channel-adding node or through the other nodes on the ring in the squelch table of the channel-dropping node, wherein the channel-dropping node detects a failed channel through which a signal does not reach the channel-dropping node among channels dropped at the channel-dropping node based on information about a location of failure on the ring, a ring-topology table managed by the channel-dropping node, and the node ID of the channel-adding node stored in the squelch table of the channel-dropping node when the failure occurs on the ring, and inserts a squelch into the failed channel.

According to the present invention, a node that drops a VT cross connection can recognize which node adds the VT cross connection by referencing a VT squelch table. Additionally, the node that drops the VT cross connection can determine insertion of a VT squelch and can insert a VT squelch to the node by using a topology table indicating positions of nodes on a network (ring) of the ring transmission system. Thus, misconnection of VT1-level lines is efficiently prevented. Further, in a conventional ring transmission system, only bridging and switching stations determine insertion of a squelch and insert the squelch to a line for all the STS1 lines. On the other hand, according to the present invention, the node that drops the VT cross connection of a line only needs to determine insertion of the VT squelch to the line dropped at the node and to insert the VT squelch to the line, thereby spreading processing load of the node to other nodes and decreasing the processing load of the node. It should be noted that it is prohibited to insert a STS1 squelch to a line where VT1 cross connection exists. On the other hand, a line where the VT1 cross connection does not exist is supported by the STS1 squelch. Accordingly, the present invention can handle a ring transmission system including both of VT1-level lines and STS1-level lines.

Other objects, features and advantages of the present invention will become more apparent from the following detailed description when read in conjunction with the accompanying drawings.

### BRIEF DESCRIPTION OF THE DRAWINGS

FIGS. 1A, 1B and 1C are diagrams showing a conventional method of constructing a ring topology;

FIGS. 2A, 2B, 2C and 2D are diagrams showing a conventional method of constructing a squelch table;

FIGS. 3A and 3B are diagrams showing a conventional method of controlling an STS1 access BLSR squelch;

FIG. 4 is a diagram showing another conventional method of controlling the STS1 access BLSR squelch:

FIGS. 5A and 5B are diagrams showing a problem about controlling the STS1 access BLSR squelch;

FIG. 6 is a block diagram showing a partial structure of a node according to a first embodiment of the present invention;

FIG. 7 is a diagram showing a data-link format of an STS squelch table according to a second embodiment of the present invention;

FIGS. 8A through 8G are diagrams showing typical processes performed while creating the STS squelch table according to the second embodiment of the present invention;

FIGS. 9A through 9N are diagrams showing a sequence of processes for creating the STS squelch table according to the second embodiment of the preset invention;

FIG. 10 is a diagram showing the data-link format of a VT squelch table according to a third embodiment of the present invention;

FIGS. 11A through 11K are diagrams showing typical processes performed while creating the VT squelch table according to the third embodiment of the present invention;

FIG. 12 is a diagram showing a network configuration in which two BLSR systems are interconnected;

FIGS. 13A through 13F are diagrams showing a sequence of processes for creating the VT squelch table in a passing-through operation according to the third embodiment of the preset invention;

FIGS. 14A through 14G are diagrams showing a sequence of processes for creating the VT squelch table in a bridging operation according to the third embodiment of the preset invention;

FIGS. 15A through 15I are diagrams showing a sequence of processes for creating the VT squelch table in a BLSR system including a service selector according to the third embodiment of the preset invention;

FIGS. 16A and 16B are diagrams showing a VT-access BLSR squelch control method according to a fourth embodiment of the present invention;

FIG. 17 is a diagram showing the VT-access BLSR squelch control method applied to a BLSR configuration in which two BLSR Systems are interconnected according to a fifth embodiment of the present invention;

FIG. 18 is a diagram showing the VT-access BLSR squelch control method applied to another BLSR configuration in which two BLSR systems are interconnected according to the fifth embodiment of the present invention; and

FIG. 19 is a diagram showing a concept of the present invention.

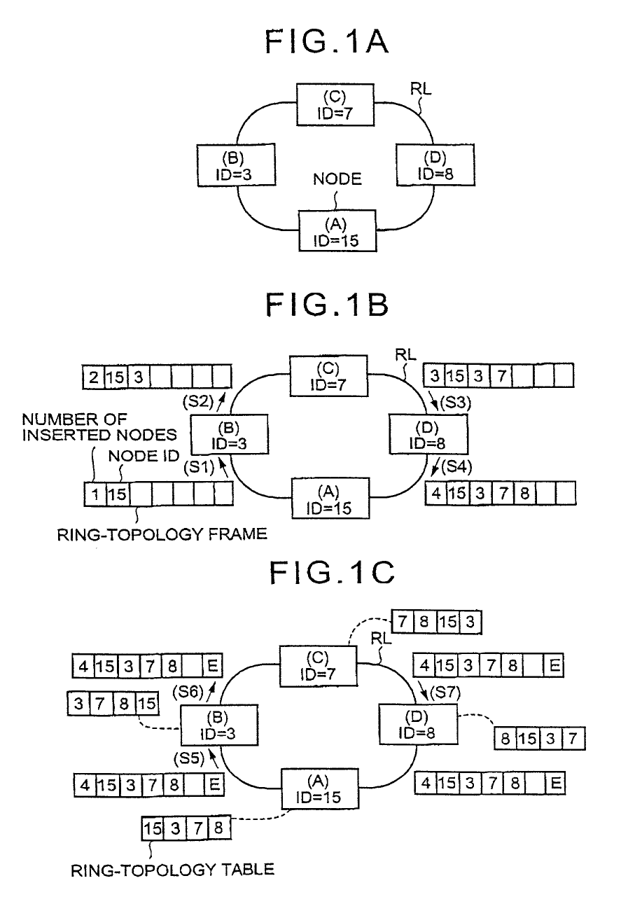

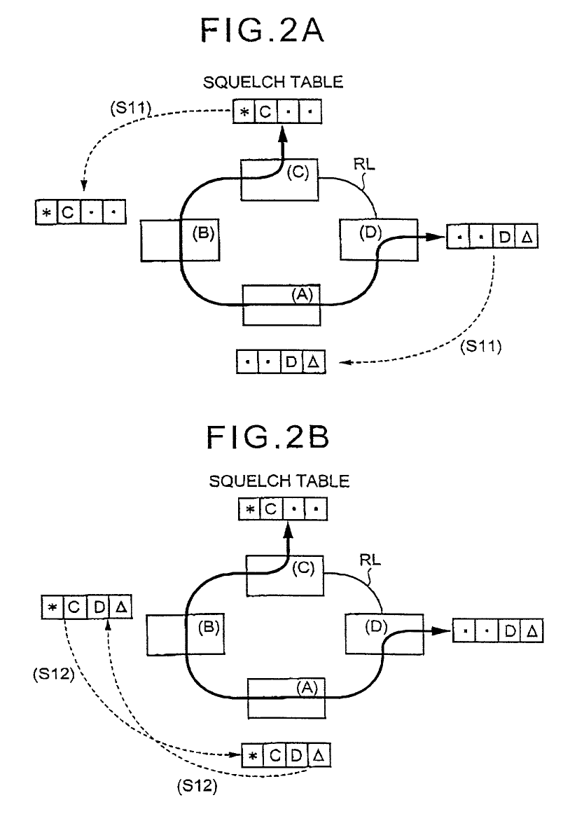

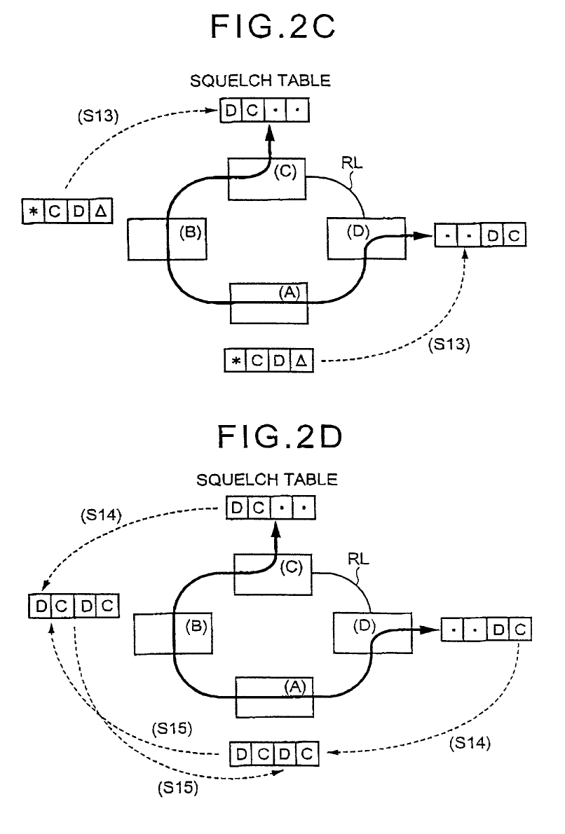

### DESCRIPTION OF THE PREFERRED EMBODIMENTS

A description will now be given of preferred embodiments of the present invention, with reference to the accompanying drawings. It should be noted that units having an identical number are the same or corresponds to each other in all the figures.

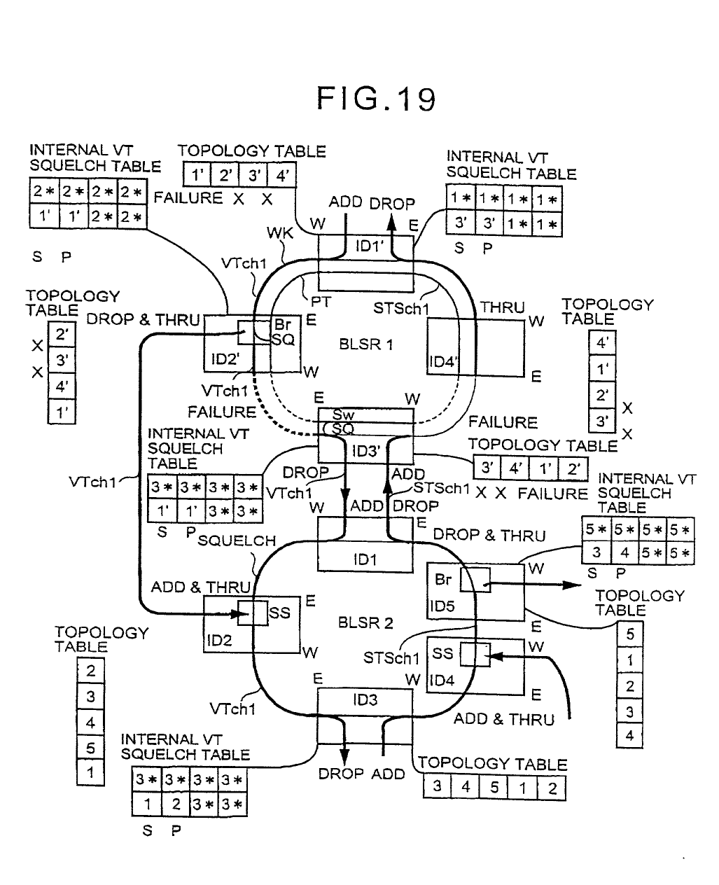

FIG. 19 is a diagram showing a concept of the present invention. A ring transmission system shown in FIG. 19 according to the present invention includes a BLSR 1 and a BLSR 2. The BLSR 1 includes nodes 1′ through 4′ respectively indicated as ID1′ through ID4′ in FIG. 19. The BLSR 2 includes nodes 1 though 5 respectively indicated as ID1 through ID5 in FIG. 19.

A channel-adding station, for example, the node 1′, adds a channel, for example, a channel VTch1, to a ring of the ring transmission system as a channel setting as well as transmits a node ID number “1′” to other nodes on the ring. A channel-dropping station, for example, the node 3′, drops the channel added to the ring as well as stores the node ID number “1′” of the channel-adding station 1′ received from the channel-adding station 1′ directly or through a plurality of the nodes in a squelch table of the channel-dropping station. When failure occurs on the ring, the channel-dropping station 3′ detects one or more channels VTch1 that do not reach the channel-dropping station 3′ among the channels VTch1 dropped at the channel-dropping station 3′, based on information about locations of the failure, for instance, an interval between the nodes 2′ and 3′, and an interval between the nodes 3′ and 4′, a ring-topology table managed by the channel-dropping station 3′, and the node ID number “1′” of the channel-adding station 1′ stored in the squelch table of the channel-dropping station 3′. Subsequently, the channel-dropping station 3′ inserts squelches at least to the detected channels located on a WK side. As describe above, the channel-dropping station 3′ can prevent misconnection of the channel VTch1 efficiently. Similarly, the channel-dropping station 101 can also prevent misconnection of a channel STSch1. In addition, a network configuration of squelch control (decision to insert a squelch and insertion of the squelch to a channel) is substantially simplified by a configuration in which only the channel-dropping station 3′ executes the squelch control, compared to a conventional method of executing the squelch control at switching and bridging stations. Accordingly, the present invention enables execution of efficient squelch control in an entire ring transmission system, at higher and lower levels, for instance, an STS1 level and a VT1 level, with management of a smaller number of the squelch tables and less decision to insert the squelch to channels compared to the conventional method, even if the number of the channels used for services increases substantially. Additionally, squelch controls of the entire network of the ring transmission system are effectively dispersed to channel-dropping stations of failed channels. Furthermore, a load on execution of the squelch control by each node in the ring transmission system is reduced according to the present invention.

The ring transmission system may also include a channel dropping/passing-through station, for instance, the node 2′ shown in FIG. 19, that drops a channel from the ring as well as passes the channel to the other nodes on the ring. The channel dropping/passing-through station 2′ stores the node ID number “1′” of the channel-adding station 1′ received from the channel-adding station 1′ in the squelch table of the channel dropping/passing-through station 2′ as well as transmits the node ID number “1′” to the other nodes on the ring for the channel setting. The channel dropping/passing-through station 2′ detects one or more of the failed channels through which a signal does not reach the channel dropping/passing-through station 2′ among the channels dropped at the channel dropping/passing-through station 2′ based on the information about the location of the failure on the ring, the ring-topology table managed by the channel dropping/passing-through station 2′ and the node ID number “1′” of the channel-adding station 1′ stored in the squelch table of the channel dropping/passing-through station 2′ when the failure occurs on the ring, and inserts the squelch to the failed channels. Accordingly, the ring transmission system can effectively prevent Disconnection of the channel VTch1 by use of the channel dropping/passing-through station 2′. Additionally, the ring transmission system can prevent misconnection of the channel STSch1 similarly to the channel VTch1. It should be noted that a squelch is not inserted to the channel VTch1 dropped at the node 2′ in the ring transmission system shown in FIG. 19 since the node 2′ is not isolated from other nodes on the ring.

The ring transmission system shown in FIG. 19 may include a service selector station, for example, the node 2, that adds a first channel from outside the ring to a second channel on the ring, and can select one of first and second channels according to communication status of the first and second channels as well as transmits a node ID number “2” of the service selector station 2 to the other nodes on the ring when creating the squelch table for the channel setting. A channel-dropping station, for instance, the node 3, detects one or more of the failed channels through which the signal does not reach the channel-dropping station 3 among the channels dropped at the channel-dropping station 3 based on the information about the location of the failure on the ring, the ring-topology table managed by the channel-dropping station 3 and the node ID numbers 1 and 2 of the respective channel-adding station 1 and service selector station 2 in the squelch table of the channel-dropping station 3 when the failure occurs on the ring, and inserts the squelch to the failed channels. Accordingly, the ring transmission system can effectively prevent misconnection of the channel VTch1 by use of the channel-dropping station 3. Additionally, the ring transmission system can prevent misconnection of the channel STSch1 similarly to the channel VTch1. It should be noted that a squelch is not inserted to the channel VTch1 dropped at the node 3 in the ring transmission system shown in FIG. 19 since the node 3 is not isolated from other nodes on the ring. In addition, the channel-dropping station 3 is closer to the service selector station 2 than to the channel-adding station 1. Thus, the service selector station 2 and the channel-adding station 1 are respectively referred to as a primary station (node) and a secondary station (node).

Additionally, according to the present invention, the channel dropping/passing-through station 5 detects one or more of the failed channels through which the signal does not reach the channel dropping/passing-through station 5 among the channels dropped at the channel dropping/passing-through station 5 based on the information about the location of the failure on the ring, the ring-topology table managed by the channel dropping/passing-through station 5 and the node ID numbers 3 and 4 of the channel-adding station 3 and of the service selector station 4 stored in the squelch table of the channel dropping/passing-through station 5 when the failure occurs on the ring, and inserts the squelch to the failed channels. Accordingly, the ring transmission system can effectively prevent misconnection of the channel VTch1 by use of the channel dropping/passing-through station 5. Additionally, the ring transmission system can prevent misconnection of the channel STSch1 similarly to the channel VTch1. It should be noted that a squelch is not inserted to the channel VTch1 dropped at the node 5 in the ring transmission system shown in FIG. 19 since the node 5 is not isolated from other nodes on the BLSR 2.

Additionally, according to the present invention, the ring transmission system preferably includes a channel passing-through station such as the node 4′ that passes the channel and the node ID number of the channel-adding station or of the service selector station received respectively from the channel-adding station or from the service selector station though the channel passing-through station to the channel-dropping station.

Additionally, the channel used in the ring transmission system preferably corresponds at least one of STS1 and VT1 accesses. In other words, the present invention may be applied to the STS1 access, the VT1 access, or a combination of the STS1 access and the VT1 access.

Additionally, the ring transmission system preferably includes a plurality of bi-directional line switched rings such as the BLSR 1 and the BLSR 2 connected to each other through nodes, each including a plurality of the nodes. In other words, the present invention may be applied to the STS1 and VT1 accesses of an interconnection between the BLSR 1 and the BLSR 2 shown in FIG. 19. In such a case, the squelch control is executed individually by each BLSR. Accordingly, the squelch control can be executed with a simple algorithm even in a case that a network configuration of the ring transmission system becomes complicated In various ways.

The squelch control is preferably not executed on an upper-level channel (STS1) at a channel-dropping station where a lower-level channel (VT1) diverges from the upper-level channel. Thus, the squelch control on the lower-level channel is individually and efficiently executed at such a channel-dropping station.

Additionally, the squelch control according to the present invention or to the conventional method is preferably executed on the upper-level channel (STS1) at a station where the lower-level channel (VT1) does not diverge from the upper-level channel. Thus, at such a station, the squelch control on the lower-level channel is executed at once by execution of the squelch control on a single upper-level channel.

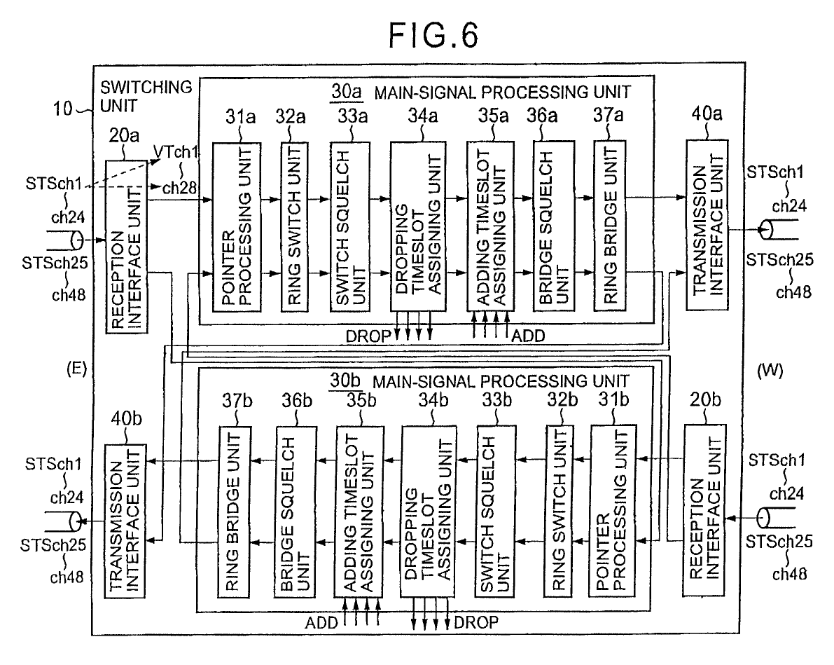

FIG. 6 is a block diagram showing a partial structure of a node according to a first embodiment of the present invention. More particularly, the partial structure of the node shown in FIG. 6 includes a structure of a BLSR switching unit capable of supporting communication control such as add, drop, through, switch, and bridge operations and squelch control for STS1 and VT1 levels. A switching unit 10 shown in FIG. 6 includes reception interface units 20a and 20b, main-signal processing units 30a and 30b, and transmission interface units 40a and 40b. The reception interface units 20a and 20b receive signals respectively from an east (E) side and a west (W) side of the switching unit 10. The transmission interface units 40a and 40b transmit signals respectively to the west side and the east side of the switching unit 10. In a case in which a transmission path is made of an optic fiber, each of the reception interface units 20a and 20b, and the transmission interface units 40a and 40b includes E/O (Electric/Optical) and O/E conversion functions.

The main-signal processing unit 30a includes a pointer processing unit 31a, a ring switch (RSW) unit 32a, switch squelch unit 33a, a dropping timeslot assigning (DROP&TSA) unit 34a, an adding timeslot assigning (ADD&TSA) unit 35a, a bridge squelch unit 36a, and a ring bridge unit 37a. The main-processing unit 30b includes a pointer processing unit 31b, a ring switch (RSW) unit 32b, switch squelch unit 33b, a dropping timeslot assigning (DROP&TSA) unit 34b, an adding timeslot assigning (ADD&TSA) unit 35b, a bridge squelch unit 36b, and a ring bridge unit 37b. Since structures of the main-signal processing units 30a and 30b are the same, a description will be given of only units in the main-signal processing unit 30a. The pointer processing unit 31a processes a pointer of a section overhead (SOH). The ring switch unit 32a switches an STS or VT channel of a spare line to a currently used line. The switch squelch unit 33a inserts or adds a squelch (P-AIS: Pass Alarm Indication Signal) to the STS or VT channel of the currently used line switched from the spare line. The dropping timeslot assigning unit 34a separates or drops a signal from a ring. The adding timeslot assigning unit 35a inserts or adds a signal to the ring. The bridge squelch unit 36a inserts or adds a squelch to the STS or VT channel of the spare line bridged from the currently used line. The ring bridge unit 37a bridges the STS or VT channel of the currently used line to the spare line. Additionally, the node includes units not shown in the figures such as a power source unit PW, a monitoring unit SV, and a control unit executing the communication control and the squelch control.

The above-described nodes-are connected to each other through two transmission paths, for example, optical fiber lines OC48. Each transmission path includes forty-eight STS1 channels in which the channels STSch1 through STSch24 are set as currently used channels (lines) WK and the channels STSch25 through STSch48 are set as spare channels (lines) PT. Additionally, each of the channels STSch1 through STSch48 includes twenty-eight VT channels VTch1 through VTch2a.

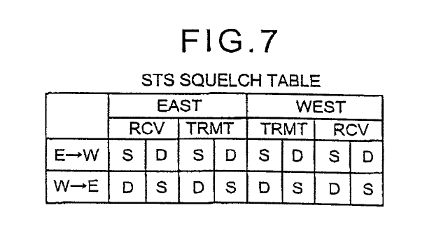

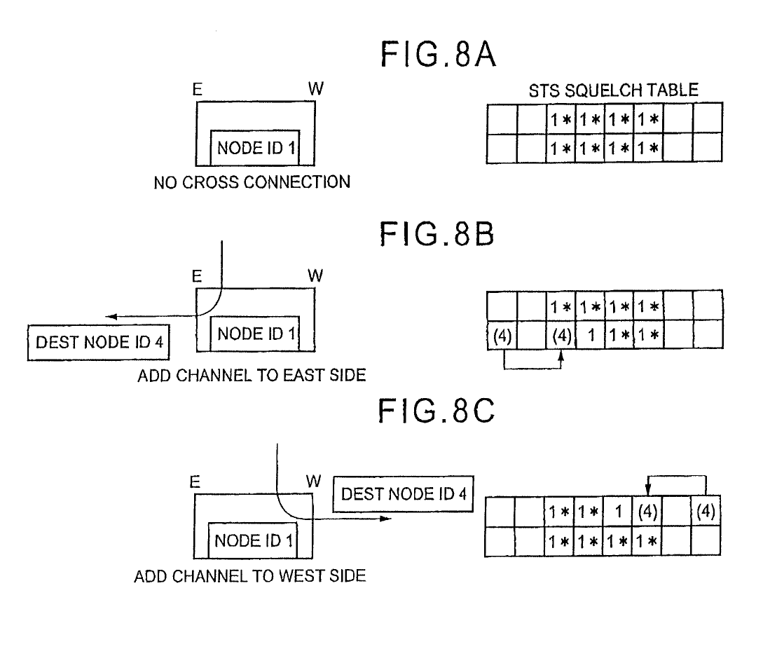

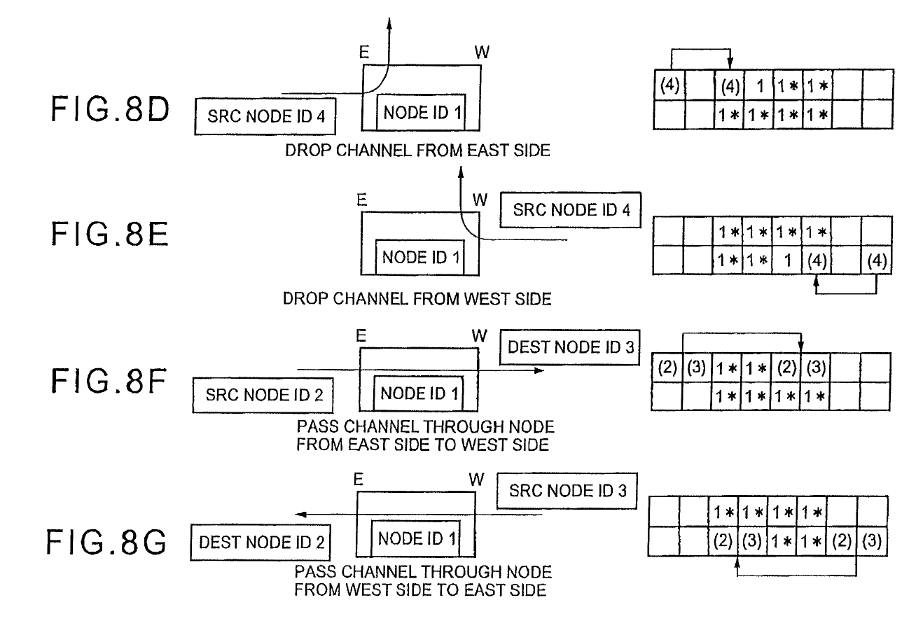

A description will now be given of a squelch-table creation process with reference to FIGS. 7 and 8A through 8G. FIG. 7 is a diagram showing a data-link format of an STS squelch table according to a second embodiment of the present invention. FIGS. 8A through 8G are diagrams showing typical processes performed while creating the STS squelch table according to the second embodiment of the present invention. In the first embodiment, squelch control is enabled at switch and bridge stations by creating a squelch table in which a source station (SRC) adding an STS channel and a destination station (DEST) dropping the STS channel are specified by intercommunication between the source station and the destination station. As shown in FIG. 7, the STS squelch table can store 8-byte information, and includes a column for the east side (EAST) of a node apparatus and another column for the west side (WEST) of the node apparatus. Each column includes data space for an E→W direction of transmitting data and a W→E direction of transmitting data. Additionally, the data space for each direction is divided into two areas, a TRMT area and a RCV area, each of the two areas respectively corresponding to transmitted data and received data. Each area for the transmitted data and the received data is managed in one byte. Furthermore, each area having one byte space is divided into two 4-bit areas, each of the 4-bit areas respectively corresponding to a source node ID area (S) and a destination node ID area (D).

A node on a network (ring) of a ring transmission system inserts an absolute node ID set in the network to data links of the STS squelch table of the node by executing a line setting or a cross-connection setting, thereby enabling recognition of the source node and the destination node of cross-connection. Accordingly, even if any station located between the source station and the destination station on the ring becomes the switch or bridge station as a result of a transmission-path failure on the ring, proper squelch control can be executed by the station located between the source station and the destination station.

A description will now be given of an STS-squelch-table creation process corresponding to each of typical cross-connection settings made by a node. The STS squelch table of the node is constructed or updated in three occasions, the first occasion being a case in which the ring transmission system starts up, the second occasion being a case in which cross-connection information of the node is changed, and the third occasion being a case in which data in the RCV area of the STS squelch table is changed. It should be noted that a sign “*” in the STS squelch table indicates an initial value Additionally, data changed In the STS squelch table is marked with a parenthesis “()”.

FIG. 8A shows the STS squelch table in a case in which no cross connection is made at the node 1. In such case, a node ID number “1*” is inserted to the source node ID area (S) and the destination node ID area (D) of the TRMT area for both of the E→W and W→E directions in the EAST and WEST columns of the STS squelch table. FIG. 8B shows the squelch table in a case in which a channel is added to the east side of the node 1. When the channel is added to the east side of the node 1, the node ID number “1” is inserted to the source node ID area (S) of the TRMT area for the W→E direction in the EAST column of the squelch table. Additionally, if the node 4 is a destination node of the channel added to the east side of the node 1, a node ID number “4” is inserted to the destination node ID area (D) of the RCV area for the W→E direction in the EAST column. When a change in the destination node ID area (D) of the RCV area for the W→E direction in the EAST column is notified by the node 4, the node 1 copies the node ID number “4” to the destination node ID area (D) of the TRMT area for the W→E direction in the EAST column of the squelch table since the node 4 is the destination of the channel to be dropped at.

FIG. 8C shows the squelch table in a case in which a channel is added to the west side of the node 1. When the channel is added to the west side of the node 1, the node ID number “1” is inserted to the source node ID area (S) of the TRMT area for the E→W direction in the WEST column of the squelch table. Additionally, if the node 4 is a destination node of the channel added to the west side of the node 1, the node ID number “4” is inserted to the destination node ID area (D) of the RCV area for the E→W direction in the WEST column. When a change in the destination node ID area (D) of the RCV area for the E→W direction in the WEST column is notified by the node 4, the node 1 copies the node ID number “4” to the destination node ID area (D) of the TRMT area for the E→W direction in the WEST column of the squelch table. As described above, a source node (adding station) adding a channel stores node ID numbers of the source node and a destination node of the channel in a squelch table for each of the E→W and W→E directions.

FIG. 8D shows the squelch table in a case in which a channel is dropped from the east side of the node 1. When the channel is dropped from the east side of the node 1, the node ID number “1” is inserted to the destination node ID area (D) of the TRMT area for the E→W direction In the EAST column of the squelch table of the node 1. Additionally, if the node 4 is a source node of the channel dropped from the east side of the node 1, the node ID number “4” is inserted to the source node ID area (S) of the RCV area for the E→W direction in the EAST column. When a change in the source node ID area (S) of the RCV area for the E→W direction in the EAST column is notified by the node 4 in a call-setting process, the node 1 copies the node ID number “4” to the source node ID area (S) of the TRMT area for the E→W direction in the EAST column of the squelch table.

FIG. 8E shows the squelch table in a case in which a channel is dropped from the west side of the node 1. When the channel is dropped from the west side of the node 1, the node ID number “1” is inserted to the destination node ID area (D) of the TRMT area for the W→E direction in the WEST column of the squelch table of the node 1. Additionally, if the node 4 is a source node of the channel dropped from the west side of the node 1, the node ID number “4” is inserted to the source node ID area (S) of the RCV area for the W→E direction in the WEST column. When a change in the source node ID area (S) of the RCV area for the W→E direction in the WEST column is notified by the node 4 in a call-setting process, the node 1 copies the node ID number “4” to the source node ID area (S) of the TRMT area for the W→E direction in the WEST column of the squelch table. As described above, a destination node (dropping station) dropping a channel stores node ID numbers of a source node and the destination node of the channel in a squelch table for each of the E→W and W→E directions.

FIG. 8F shows the squelch table in a case in which data is passed from the node 2 as a source node to the node 3 as a destination node through the node 1. Initially, node ID numbers “2” and “3” are stored respectively in the source node ID area (S) and the destination node ID area (D) of the RCV area for the E→W direction in the EAST column of the squelch table. When a change in the source node ID area (S) and the destination node ID area (D) of the RCV area for the E→W direction is notified, the node 1 copies the node ID numbers “2” and “3” respectively to the source node ID area (S) and the destination node ID area (D) of the TRMT area for the E→W direction in the WEST column of the squelch table. FIG. 8G shows the squelch table in a case in which data is passed from the node 3 as the source node to the node 2 as the destination node through the node 1. Initially, node ID numbers “2” and “3” are stored respectively in the destination node ID area (D) and the source node ID area (S) of the RCV area for the W→E direction in the WEST column of the squelch table. When a change in the source node ID area (S) and the destination node ID area (D) of the RCV area for the W→E direction is notified, the node 1 copies the node ID numbers “2” and “3” respectively to the destination node ID area (D) and the source node ID area (S) of the TRMT area for the W→E direction in the EAST column of the squelch table. As described above, a passing-through station stores node ID numbers of a source node and s destination node of a channel in a squelch table for each of the E→W and W→E directions.

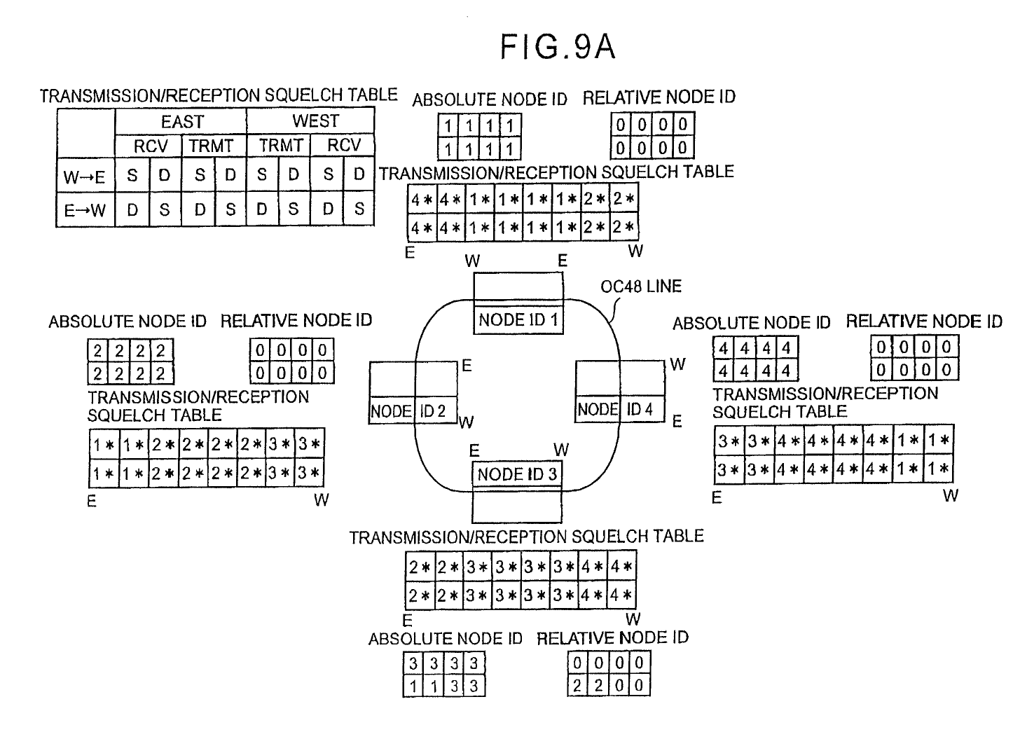

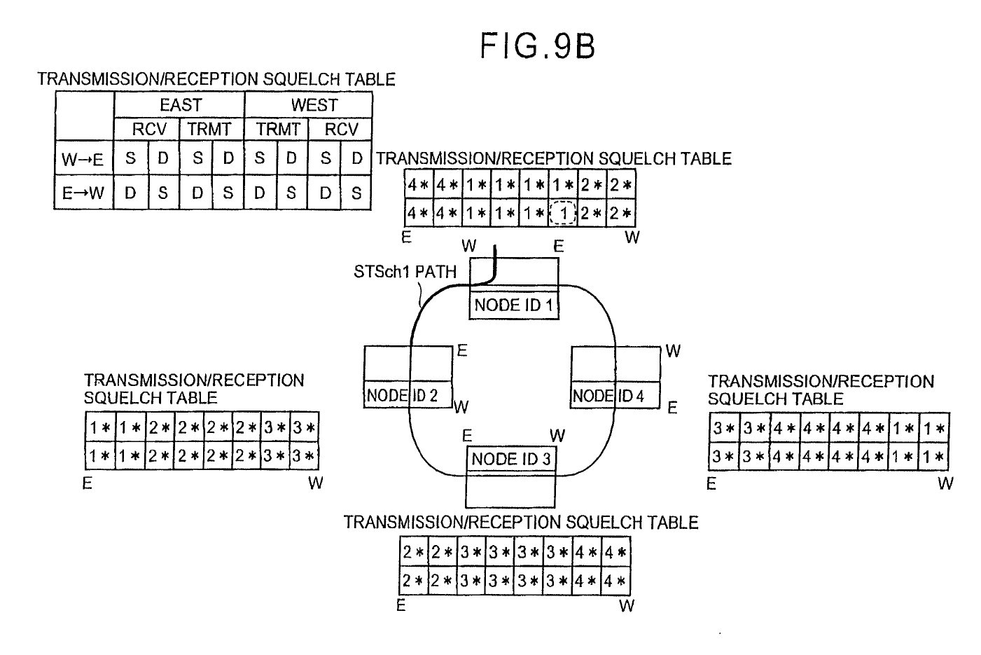

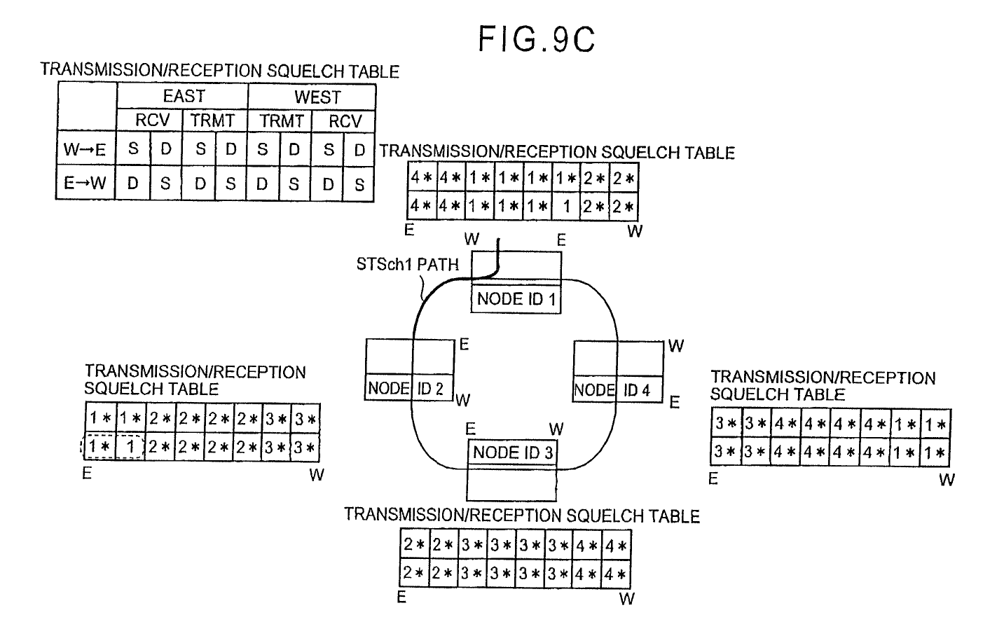

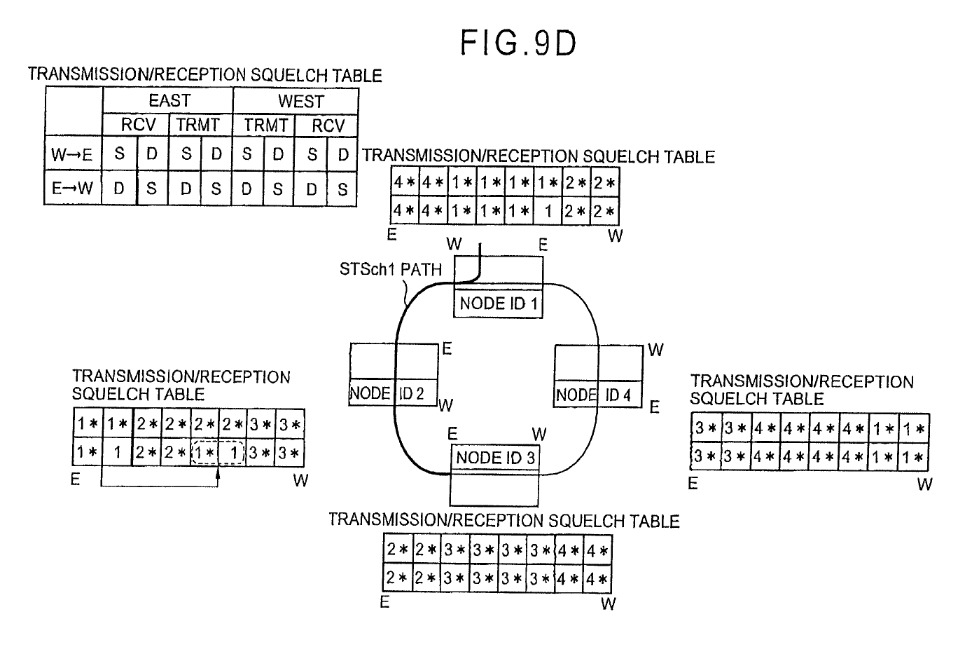

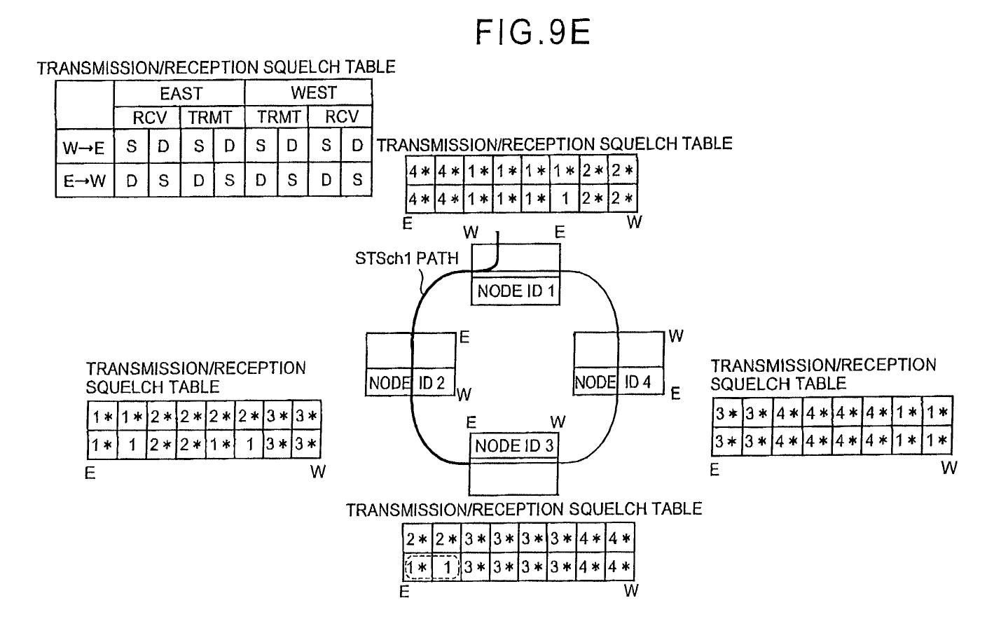

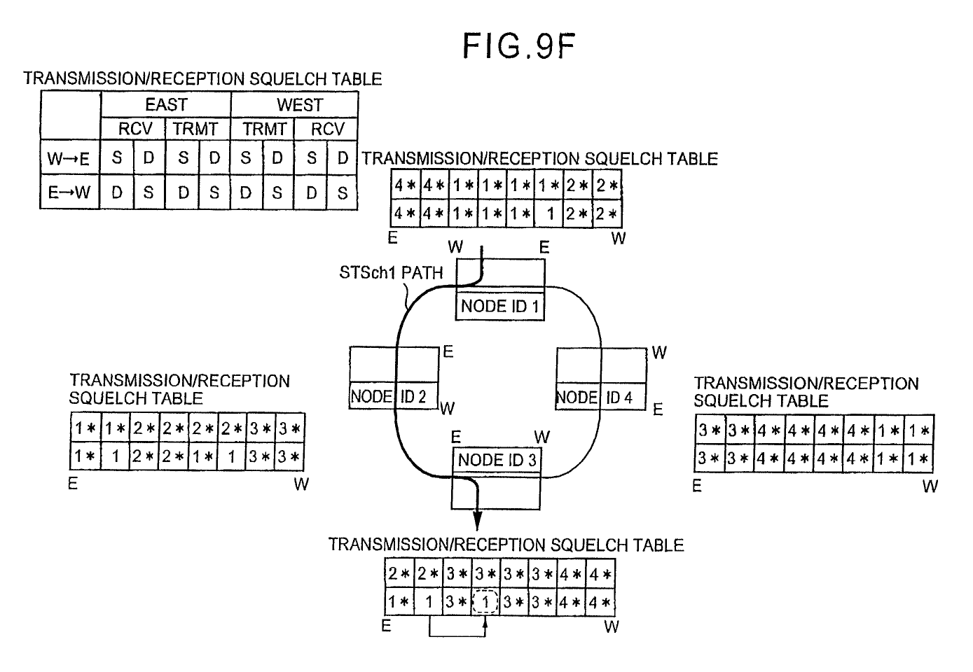

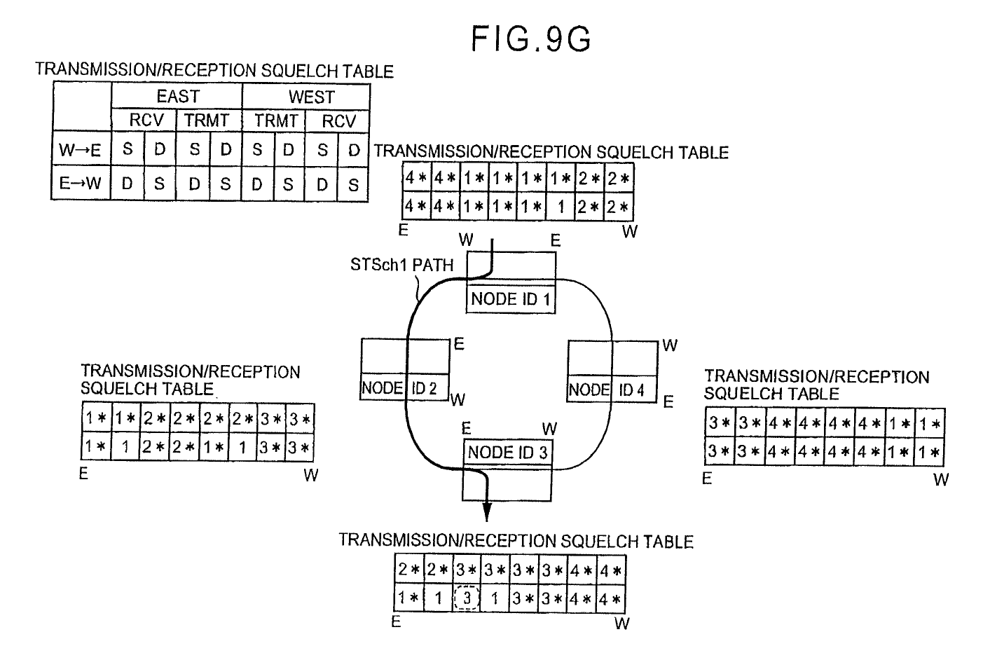

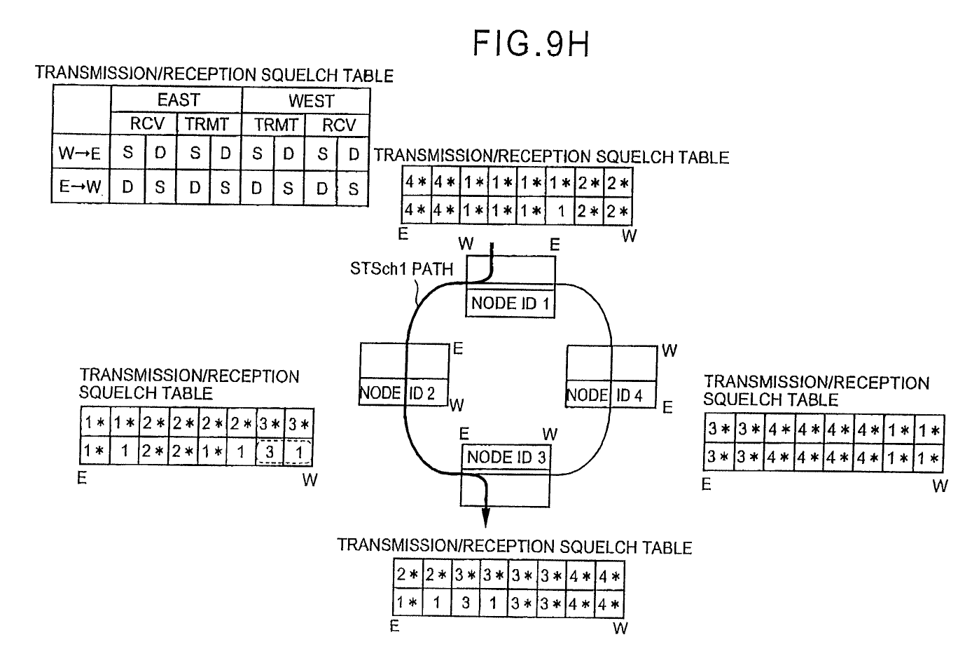

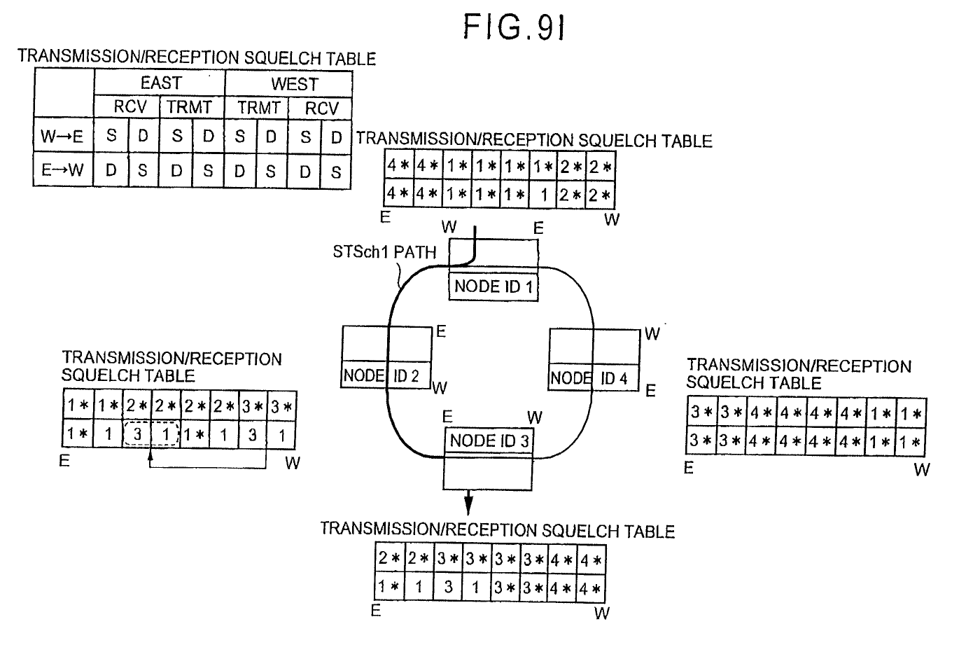

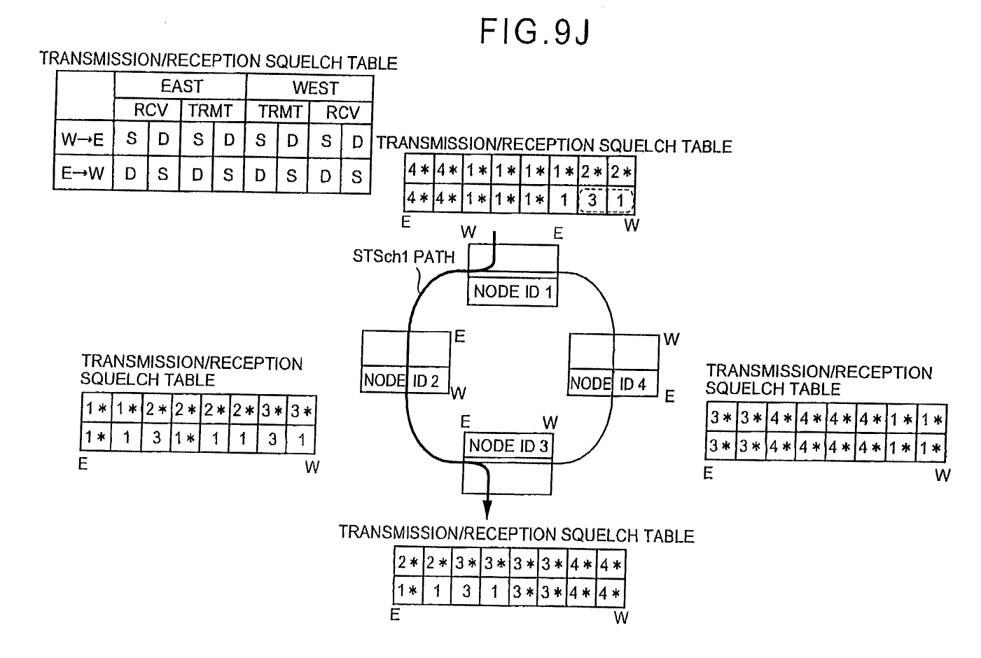

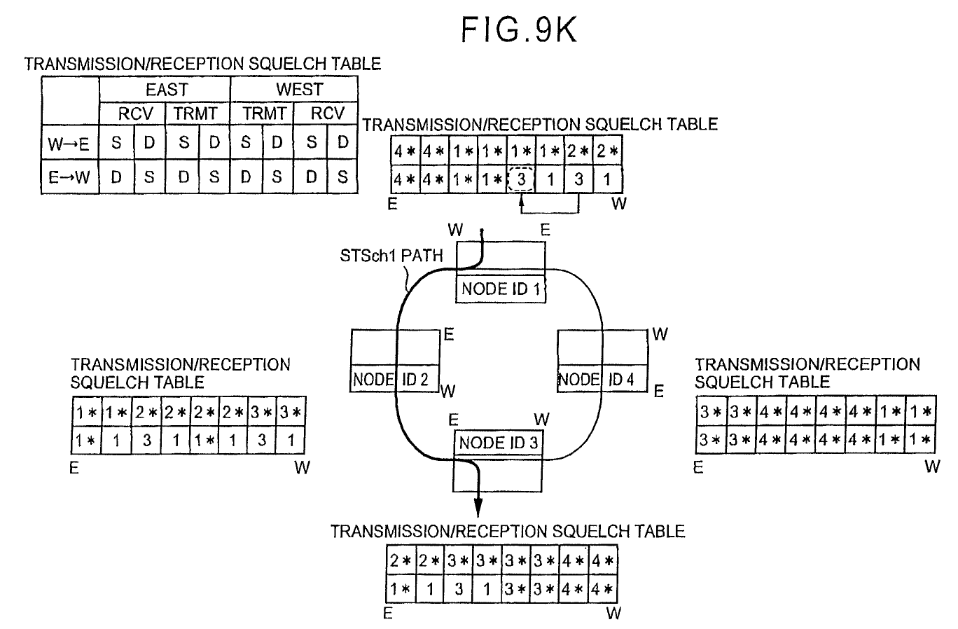

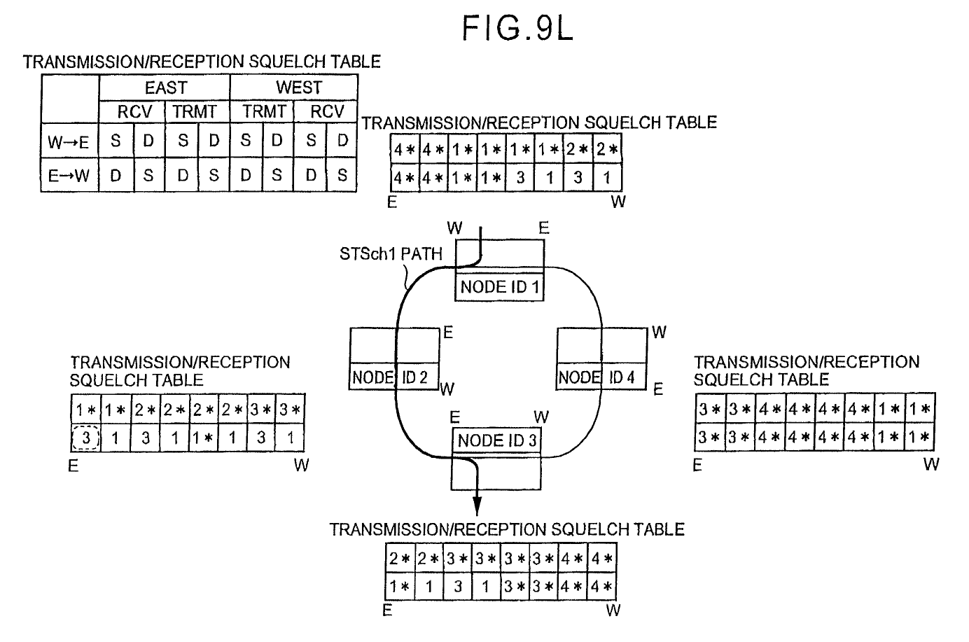

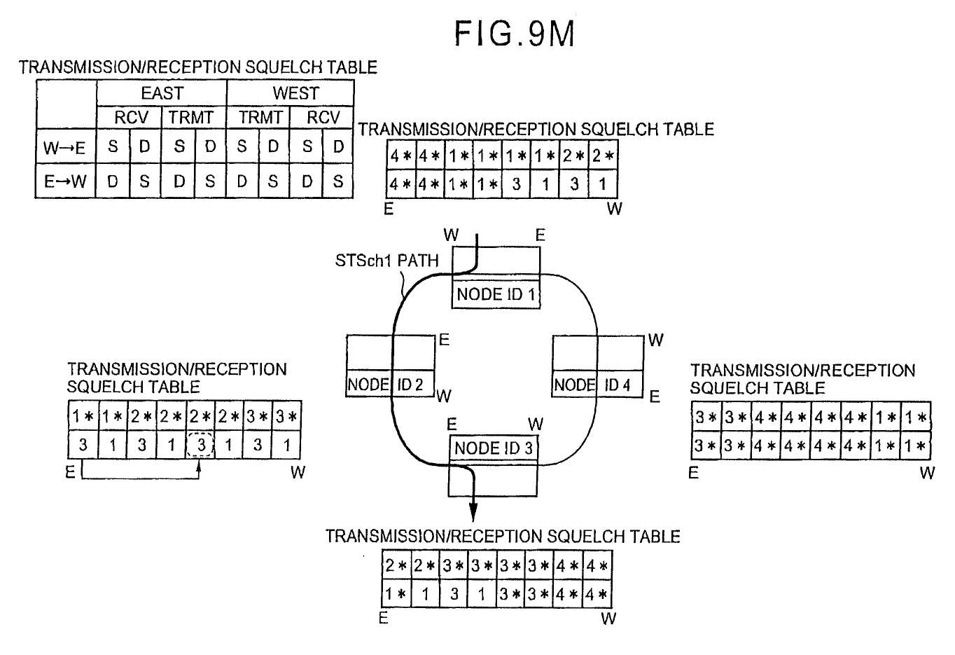

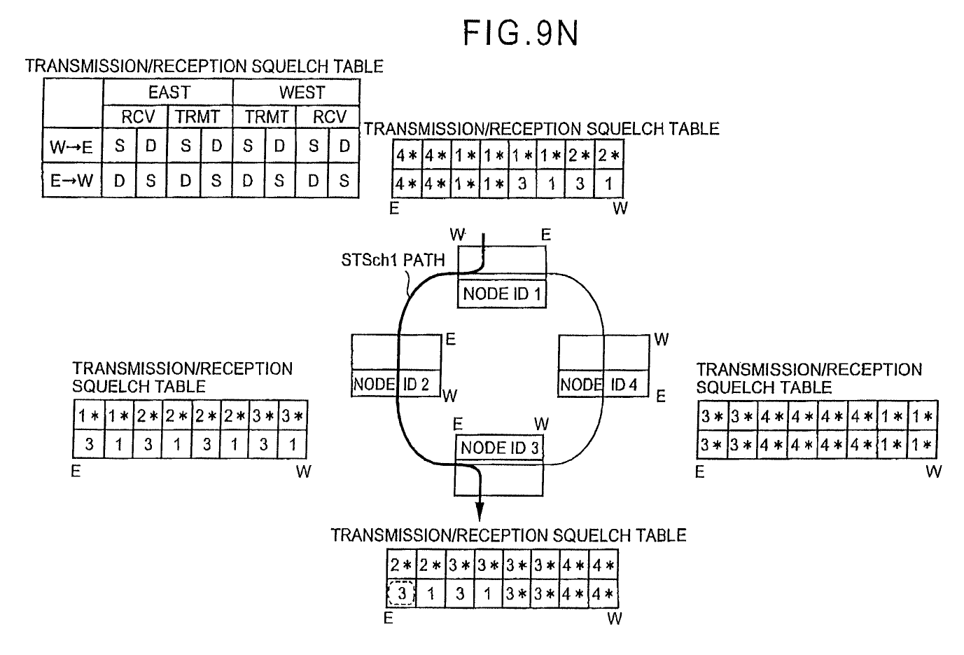

FIGS. 9A through 9N are diagrams showing a sequence of processes for creating an STS squelch table in a case in which the STS channel 1 (STSch1) is added at the node 1 and dropped at the node 3 according to the second embodiment of the present invention. FIG. 9A shows an initial condition in which no cross connection is made at every node on a ring. At each node on the ring, a node ID number of the node is stored in TRMT areas of the STS squelch table, which is shown as a transmission/reception squelch table in FIG. 9A. RCV areas of the STS squelch table include node ID numbers of adjacent nodes. Additionally, as shown in FIG. 9A, each of the nodes 1, 2, 3 and 4 on the ring includes an absolute node ID table for node ID numbers of absolute nodes and a relative node ID table for node ID numbers of a relative node. A node ID number of a relative node stored in the relative node ID table at a node on the ring is “0”. Hereinafter, node ID numbers of a source node placed in a source node ID area (S) of a TRMT area and a RCV area in the STS squelch table are respectively referred to as a TRMT(S) and a RCV(S) for a description purpose. Similarly, node ID numbers of a destination node placed in a destination node ID area (D) of the TRMT area and the RCV area in the STS squelch table are respectively referred to as a TRMT(D) and a RCV(D).

As shown in FIG. 9B, the node 1 adds the STSch1 in the E→W direction by a call setting since the node 1 is set as an adding station. The node ID number “1” is inserted to the source node ID area (S) of the TRMT area for the E→W direction in the WEST column of an STS squelch table of the node 1. In other words, the TRMT(S) for the E→W direction in the West column of the STS squelch table is set to “1”. Additionally, the node 1 transmits a TRMT(S, D)=(1, 1*) to the node 2. The TRMT(D)=(1*) indicates that the TRMT(D) is unknown.

The node 2 receives the TRMT(s, D)=(1, 1*) for the E→W direction from the node 1 through the east side of the node 2, and records the received TRMT(S, D)=(1, 1*) as a RCV(S, D)=(1, 1*) for the E→W direction in the EAST column of an STS squelch table of the node 2 as shown in FIG. 9C. Additionally, the node 2 passes the STSch1 in the E→W direction through the node 2 since the node 2 is determined as a passing-through station by the call setting. The node 2 also copies the values (1, 1*) of the RCV(S, D) for the E→W direction in the EAST column to the TRMT(S, D) for the E→W direction in the WEST column in the STS squelch table as shown in FIG. 9D. Additionally, the node 2 transmits the TRMT(S, D)=(1, 1*) for the E→W direction in the WEST column to the node 3.

The node 3 receives the TRMT(S, D)=(1, 1*) for the E→W direction from the node 2 through the east side of the node 3, and records the received TRMT(S, D)=(1, 1*) as the RCV(S, D)=(1, 1*) for the E→W direction in the EAST column of an STS squelch table of the node 3, as shown in FIG. 9E. In addition, the node 3 drops the STSch1 therefrom in the E→W direction since the node 3 is determined as a dropping station by the call setting. Further, the node 3 copies the value (1) of the RCV(S) for the E→W direction in the EAST column to the TRMT(S) for the E→W direction in the WEST column of the STS squelch table of the node 3 as shown in FIG. 9F. The node 3 also sets a node ID number “3” to the TRMT(D) for the E→W direction in the EAST column of the STS squelch table of the node 3 as shown in FIG. 9G. The node 3 then transmits a TRMT(S, D)=(1, 3) to the node 2.

The node 2 receives the TRMT(S, D)=(1, 3) for the E→W direction from the node 3 through the west side of the node 2, and records the received TRMT(S, D)=(1, 3) as a RCV(S, D)=(1, 3) for the E→W direction in the WEST column of the STS squelch table of the node 2, as shown in FIG. 9H. The node 2 also copies the values (1, 3) of the RCV(S, D)=(1, 3) for the E→W direction in the WEST column to the TRMT(S, D) for the E→W direction in the EAST column of the STS squelch table as shown in FIG. 9I since the node 2 is determined as the passing-through station by the call setting. Additionally, the node 2 transmits the TRMT(S, D)=(1, 3) for the E→W direction In the EAST column of the STS squelch table to the node 1.

Subsequently, the node 1 receives the TRMT(S. D)=(1, 3) for the E→W direction from the node 2 through the west side of the node 1, and records the received TRMT(S, D)-=(1, 3) as a RCV(S, D)=(1, 3) for the E→W direction in the WEST column of the STS squelch table of the node 1 as shown in FIG. 9J. The node 1 also copies the value (3) of the RCV(D) for the E→W direction in the WEST column to the TRMT(D) for the E→W direction in the WEST column of the STS squelch table of the node 1 as shown in FIG. 9K. Additionally, the node 1 transmits the TRMT(D)=(3) for the E→W direction in the WEST column of the STS squelch table to the node 2.

The node 2 receives the TRMT(D)=(3) for the E→W direction from the node 1 through the east side of the node 2, and records the received TRMT(D)=(3) as a RCV(D)=(3) for the E→W direction in the EAST column of the STS squelch table of the node 2 as shown in FIG. 9L. The node 2 then copies the value (3) of the RCV(D) for the E→W direction in the EAST column to the TRMT(D) for the E→W direction In the WEST column of the STS squelch table as shown in FIG. 9M since the node 2 is determined as the passing-through station by the call setting. In addition, the node 2 transmits the TRMT(D)=(3) for the E→W direction in the WEST column of the STS squelch table to the node 3.

The node 3 receives the TRMT(D)=(3) for the E→W direction from the node 2 through the east side of the node 3, and records the received TRMT(D)=(3) as a RCV(D)=(3) for the E→W direction in the EAST column of the STS squelch table of the node 3 as shown in FIG. 9N. The TRMT(S, D) and the RCV(S, D) are equal to the values (1, 3) in the STS squelch table of the node 3, and thus the sequence of the processes for creating the STS squelch table is completed.

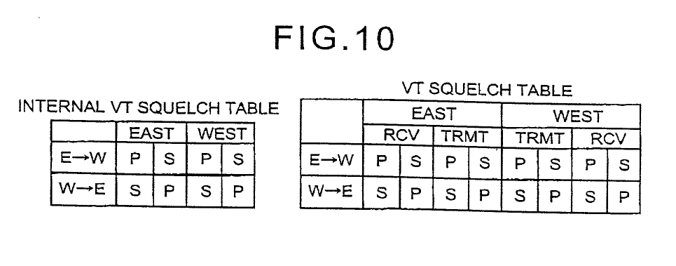

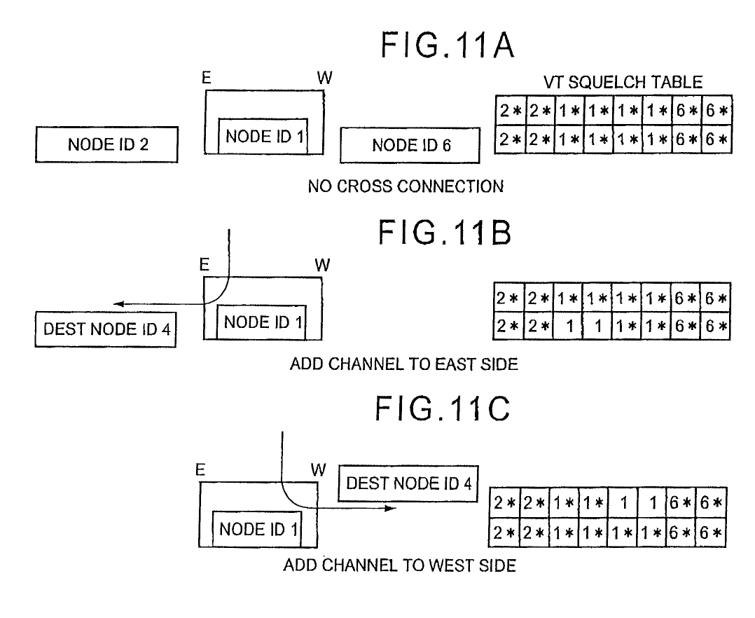

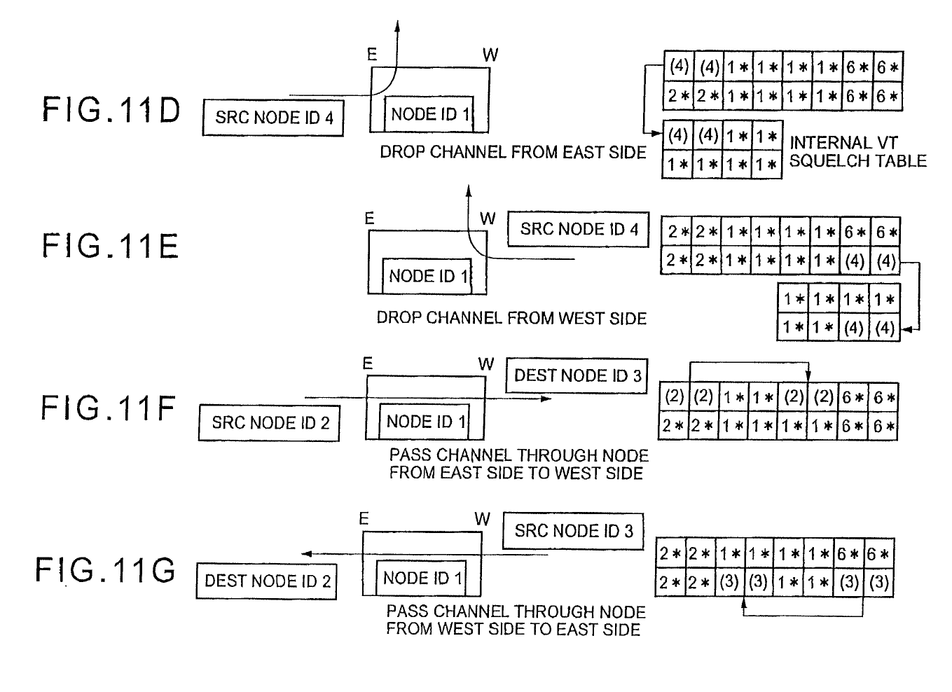

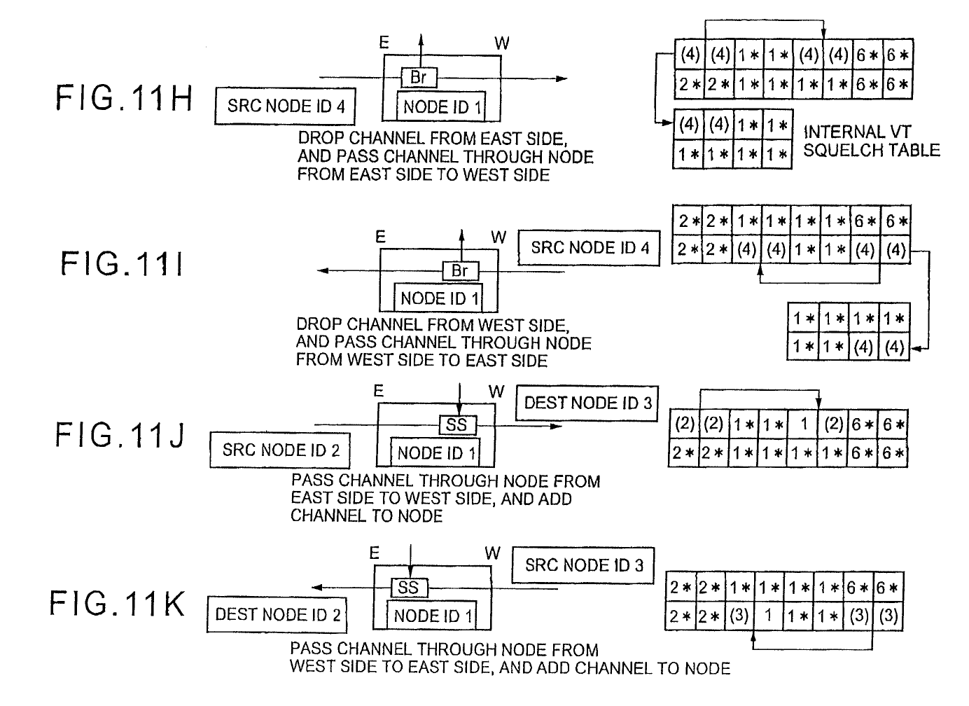

FIG. 10 is a diagram showing a data-link format of a VT squelch table according to a third embodiment of the present invention. FIGS. 11A through 11K are diagrams showing typical processes performed while creating the VT squelch table according to the third embodiment of the present invention. FIGS. 11A through 11K particularly show cases in which squelch control can be executed at a destination station (dropping station) that drops a VT channel by constructing a squelch table storing information about a source station (adding station) adding the VT channel in the destination station by use of one-way communication from the source station to the destination station. It is assumed that a channel setting is executed at the VT1 level in the third embodiment. In order to insert a VT squelch to a channel on a ring of a ring transmission system, it is necessary to recognize which station on the ring has initially added a cross connection that is dropped. In other words, it is necessary to construct a VT squelch table and then to insert the VT squelch to the channel based on information stored in the VT squelch table at a station where the cross connection between stations is dropped.

The data-link format of the VT squelch table shown in FIG. 10 includes a column for the east side of a node (EAST column) and another column for the west side of the node (WEST column). Each column includes data space for an E→W direction of transmitting data and a W→E direction of transmitting data. Additionally, the data space for each direction is divided into two areas, a TRMT area and a RCV area, each of the two areas respectively corresponding to transmitted data and received data. Each area for the transmitted data and the received data is managed in one byte. Furthermore, each of the TRMT area and the RCV area is divided into two 4-bit areas, each of the 4-bit areas respectively corresponding to a primary node ID area (P) and a secondary node ID area (S). A node on a network (ring) of the ring transmission system inserts an absolute node ID set in the network to data links of the VT squelch table of the node by executing a line setting or a VT cross-connection setting, thereby enabling recognition of a node where a VT cross connection is added to. Additionally, FIG. 10 includes a data-link format of an internal VT squelch table used for deciding insertion of a VT squelch to a channel.

The insertion of a VT squelch to a node is executed differently from insertion of a STS squelch to a node. The STS squelch is Inserted to a switching node and a bridging node, whereas the VT squelch is inserted to a node that drops a VT cross connection or a VT-mapped STS path. Therefore, construction of the VT squelch table is executed differently from that of the STS squelch table.

A description will now be given of a VT-squelch-table creation process corresponding to each of typical VT cross-connection settings made by a node. The VT squelch table of a node is basically constructed or updated in three occasions, the first occasion being a case in which the ring transmission system starts up, the second occasion being a case in which cross-connection information of the node is changed, and the third occasion being a case in which data in the RCV area of the STS squelch table is changed. It should be noted that the sign “*” in the VT squelch table indicates an initial value. Additionally, data changed in the VT squelch table is marked with a parenthesis “()”.

FIG. 11A shows the VT squelch table in a case in which no cross connection is made at the node 1. In such case, a node ID number “1*” is inserted to the primary node ID area (P) and the secondary node ID area (S) of the TRMT area for both of the E→W and W→E directions in the EAST and WEST columns of the VT squelch table. Additionally, a node ID number “2*” of a node adjacent to the east side of the node 1 is inserted to the primary node ID area (P) and the secondary node ID area (S) of the RCV area for both of the E→W and W→E directions in the EAST column of the VT squelch table. Additionally, a node ID number “6*” of a node adjacent to the west side of the node 1 is inserted to the primary node ID area (P) and the secondary node ID area (S) of the RCV area for both of the E→W and W→E directions in the WEST column of the VT squelch table.

FIG 11B shows the VT squelch table in a case in which a VT channel is added to the east side of the node 1. When the VT channel is added to the east side of the node 1, the node 1 inserts the node ID number “1” to the primary node ID area (P) and the secondary node ID area (S) of the TRMT area for the W→E direction in the EAST column of the VT squelch table since the node 1 becomes a source node by adding the VT channel thereto. FIG. 11C shows the VT squelch table in a case In which a VT channel is added to the west side of the node 1. When the VT channel is added to the west side of the node 1, the node 1 inserts the node ID number “1” to the primary node ID area (P) and the secondary node ID area (S) of the TRMT area for the E→W direction in the WEST column of the VT squelch table since the node 1 becomes a source node by adding the VT channel thereto. FIG. 11D shows the VT squelch table in a case in which a VT channel is dropped from the east side of the node 1. The node 1 inserts a node ID number “4” to the primary node ID area (P) and the secondary node ID area (S) of the RCV area for the E→W direction in the EAST column of the VT squelch table of the node 1 since the node 4 is a source node of the VT channel dropped from the east side of the node 1. Additionally, when a change in the RCV area for the E→W direction in the EAST column of the VT squelch table of the node 1 is notified by the node 4 in a call-setting process, the node 1 copies the node ID number “4” to the primary node ID area (P) and the secondary node ID area (S) for the E→W direction in the EAST column of the internal VT squelch table used for deciding insertion of the VT squelch to a node. Accordingly, the VT squelch table and the internal VT squelch table indicate that the VT channel is added at the node 4 and dropped at the node 1.

FIG. 11E shows the VT squelch table in a case in which a VT channel is dropped from the west side of the node 1. The node 1 inserts a node ID number “4” to the primary node ID area (P) and the secondary node ID area (S) of the RCV area for the W→E direction in the WEST column of the VT squelch table of the node 1 since the node 4 is a source node of the VT channel dropped from the west side of the node 1. Additionally, when a change in the RCV area for the W→E direction in the WEST column of the VT squelch table of the node 1 is notified by the node 4 in the call-setting process, the node 1 copies the node ID number “4” to the primary node ID area (P) and the secondary node ID area (S) for the W→E direction in the WEST column of the internal VT squelch table used for deciding insertion of the VT squelch to a node. Accordingly, the VT squelch table and the internal VT squelch table that the VT channel is added at the node 4 and dropped at the node 1.

FIG. 11F shows the VT squelch table in a case in which the node 1 receives data from the node 2 as a source node at the east side of the node 1 and passes the data to the node 3 as a destination node from the west side of the node 1. Initially, the node 1 inserts the node ID number “2” to the primary node ID area (P) and the secondary node ID area (S) of the RCV area for the E→W direction in the EAST column of the VT squelch table. When a change in the RCV area for the E→W direction in the EAST column is notified by the node 2, the node 1 copies the node ID number “2” to the primary node ID area (P) and the secondary node ID area (S) of the TRMT area for the E→W direction in the WEST column of the VT squelch table. Accordingly, the data is passed from the node 2 through the node 1 to the node 3. FIG. 11G shows the VT squelch table in a case in which the node 1 receives data from the node 3 as a source node at the west side of the node 1 and passes the data to the node 2 as a destination node from the east side of the node 1. Initially, the node 1 inserts the node ID number “3” to the primary node ID area (P) and the secondary node ID area (S) of the RCV area for the W→E direction in the WEST column of the VT squelch table. When a change in the RCV area for the W→E direction in the WEST column is notified by the node 3, the node 1 copies the node ID number “3” to the primary node ID area (P) and the secondary node ID area (S) of the TRMT area for the W→E direction in the EAST column of the VT squelch table. Accordingly, the data is passed from the node 3 through the node 1 to the node 2. It should be noted that the above-described process to pass the data through the node 1 may be performed by hardware.

FIG. 11H shows the VT squelch table in a case in which a VT channel from the node 4 as a source node is dropped at the east side of the node 1 and is also passed through the node 1 to a node adjacent to the west side of the node 1. In such case, the node 1 inserts the node ID number “4” to the primary node ID area (P) and the secondary node ID area (S) of the RCV area for the E→W direction in the EAST column of the VT squelch table. When receiving a change in the RCV area for the E→W direction in the EAST column of the VT squelch table from the node 4, the node 1 copies the node ID number “4” to the primary node ID area (P) and the secondary node ID area (S) of the EAST column for the E→W direction in the internal VT squelch table, since the node 1 is a dropping station. Additionally, the node 1 copies the node ID number “4” to the primary node ID area (P) and the secondary node ID area (S) of the TRMT area for the E→W direction in the WEST column of the VT squelch table since the node 1 is also a passing-through station, Accordingly, the node 1 can realize that the VT channel dropped at the node 1 was initially added at the node 4. In addition, information that the VT channel is added at the node 4 and dropped at the node 1 is passed through the node to a node adjacent to the west side of the node 1.

FIG. 11I shows the VT squelch table in a case in which a VT channel from the node 4 as a source node is dropped at the west side of the node 1 and is also passed through the node 1 to a node adjacent to the east side of the node 1. In such case, the node 1 inserts the node ID number “4” to the primary node ID area (P) and the secondary node ID area (S) of the RCV area for the W→E direction in the WEST column of the VT squelch table. When receiving a change in the RCV area for the W→E direction in the WEST column of the VT squelch table from the node 4, the node 1 copies the node ID number “4” to the primary node ID area (P) and the secondary node ID area (S) of the WEST column for the W→E direction in the internal VT squelch table. Additionally, the node 1 copies the node ID number “4” to the primary node ID area (P) and the secondary node ID area (S) of the TRMT area for the W→E direction in the EAST column of the VT squelch table. Accordingly, the node 1 can realize that the VT channel dropped at the node 1 was initially added at the node 4. In addition, information that the VT channel is added at the node 4 and dropped at the node 1 is passed through the node to a node adjacent to the east side of the node 1.

FIG. 11J shows the VT squelch table in a case in which the node 1 receives a VT channel from the node 2 as a source node at the east side of the node 1, passes the VT channel from the west side of the node 1 to the node 3 as a destination node, and adds the VT-channel to the node 1 by use of a service selector SS. In such case, the node 1 inserts the node ID number “2” to the primary node ID area (P) and the secondary node ID area (S) of the RCV area for the E→W direction in the EAST column of the VT squelch table. When receiving a change in the RCV area for the E→W direction in the EAST column of the VT squelch table from the node 2 as the source node, the node 1 copies the node ID number “2” to the primary node ID area (P) and the secondary node ID area (S) of the TRMT area for the E→W direction in the WEST column of the VT squelch table since the node 1 is a passing-through node. Additionally, since the node 1 is also a adding station, the node 1 replaces the node ID number “2” with the node ID number “1” in the primary node ID area (P) of the TRMT area for the E→W direction in the WEST column of the VT squelch table, Accordingly, the primary and secondary stations in the TRMT area for the E→W direction become respectively the node 1 and the node 2. Subsequently, the node 1 notifies a node adjacent to the west side of the node 1 that the primary and secondary stations in the TRMT area for the E→W direction are respectively the node 1 and the node 2.

FIG. 11K shows the VT squelch table in a case in which the node 1 receives a VT channel from the node 3 as a source node at the west side of the node 1, passes the VT channel from the east side of the node 1 to the node 2 as a destination node, and adds the VT channel to the node 1 by use of the service selector SS. In such case, the node 1 inserts the node ID number “3” to the primary node ID area (P) and the secondary node ID area (S) of the RCV area for the W→E direction in the WEST column of the VT squelch table. When receiving a change in the RCV area for the W→E direction in the WEST column of the VT squelch table from the node 3 as the source node, the node 1 copies the node ID number “3” to the primary node ID area (P) and the secondary node ID area (S) of the TRMT area for the W→E direction in the EAST column of the VT squelch table since the node 1 is a passing-through node. Additionally, since the node 1 is also a adding station, the node 1 replaces the node ID number “3” with the node ID number “1” in the primary node ID area (P) of the TRMT area for the W→E direction in the EAST column of the VT squelch table. Accordingly, the primary and secondary stations in the TRMT area for the W→E direction become respectively the node 1 and the node 3. Subsequently, the node 1 notifies a node adjacent to the east side of the node 1 that the primary and secondary stations in the TRMT area for the W→E direction are respectively the node 1 and the node 3.

According to the third embodiment of the present invention, a node that drops a VT cross connection can recognize which node adds the VT cross connection by referencing the above-described VT squelch table. Additionally, the node that drops the VT cross connection can determine insertion of a VT squelch and can insert the VT squelch to the node by using a topology table indicating positions of nodes on the network (ring) of the ring transmission system. Thus, misconnection of VT1-level lines is efficiently prevented. Furthers in a conventional ring transmission system, bridging and switching stations determine insertion of a squelch and insert the squelch to a line for all the STS1 lines. On the other hand, according to the third embodiment, a node that drops a VT cross connection of a line only needs to determine insertion of a VT squelch to the line dropped at the node and to insert the VT squelch to the line, thereby spreading processing load of the node to other nodes and decreasing the processing load of the node. It should be noted that it is prohibited to insert a STS1 squelch to a line where VT1 cross connection exists. On the other hand, a line where the VT1 cross connection does not exist is supported by the STS1 squelch. Accordingly, the present invention can handle a ring transmission system including both of VT1-level lines and STS1-level lines.

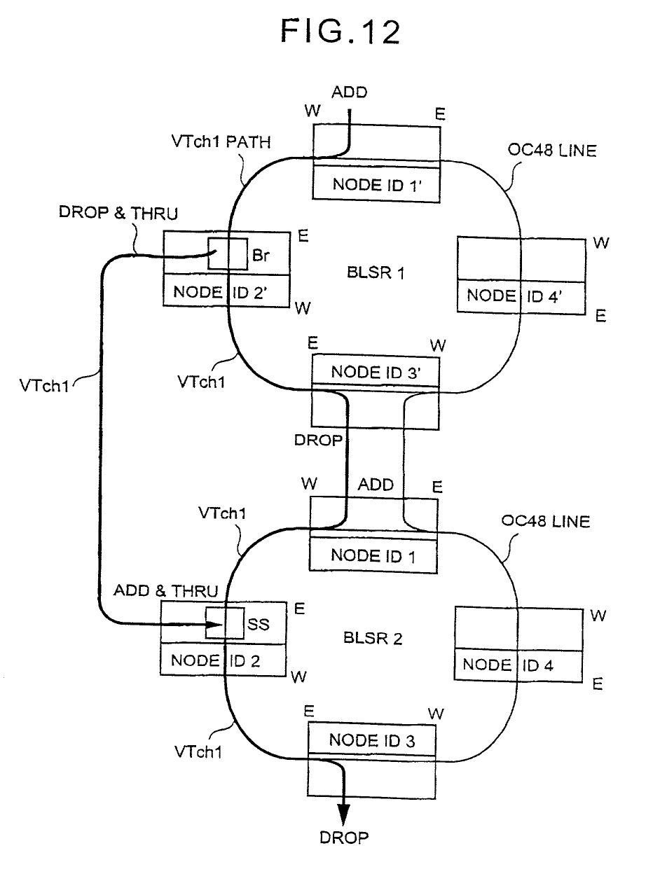

FIG. 12 is a diagram showing a network configuration in which two BLSR systems are interconnected. The network configuration shown in FIG. 12 includes a BLSR 1 and a BLSR 2. It should be noted that a node ID number of each node in a BLSR should be unique only in the BLSR where the node belongs. However, for a description purpose, four nodes included in the BLSR 1 are named nodes 1′ through 4′. Similarly, four nodes included in the BLSR 2 are named nodes 1 through 4. As shown in FIG. 12, a channel VTch1 is initially added at the node 1′ of the BLSR 1, and then is separated at the node 2′. To be concrete, the VTch1 is dropped at the node 2′ as well as is passed through the node 2′ to the node 3′ in the BLSR 1. The VTch1 dropped at the node 2′ is added at the node 2 by using the service selector SS, and is again dropped at the node 3 of the BLSR 2. On the other hand, the VTch1 passed to the node 3′ of the BLSR 1 is dropped therefrom, and is added at the node 1 of the BLSR 1. Subsequently, the VTch1 added at the node 1 is passed through the node 2 to the node 3 where the VTch1 is dropped.

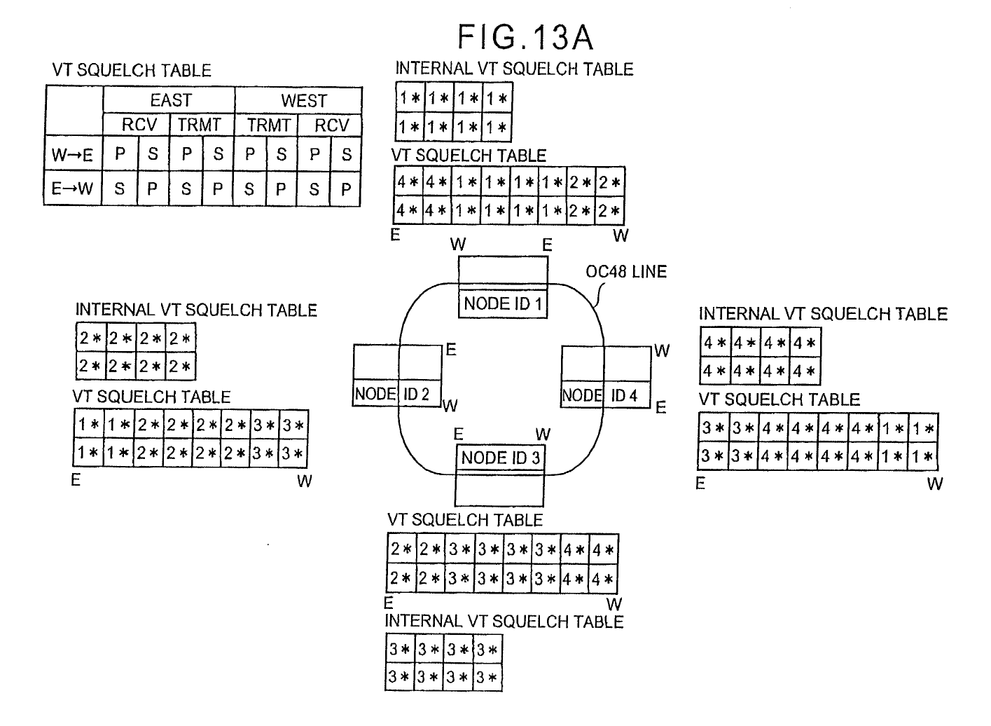

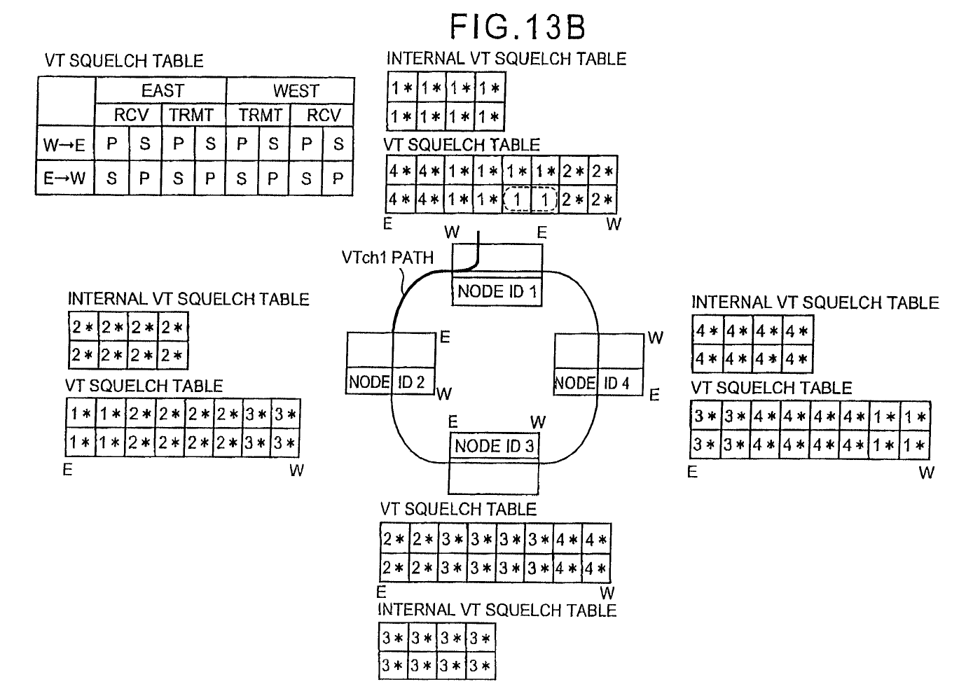

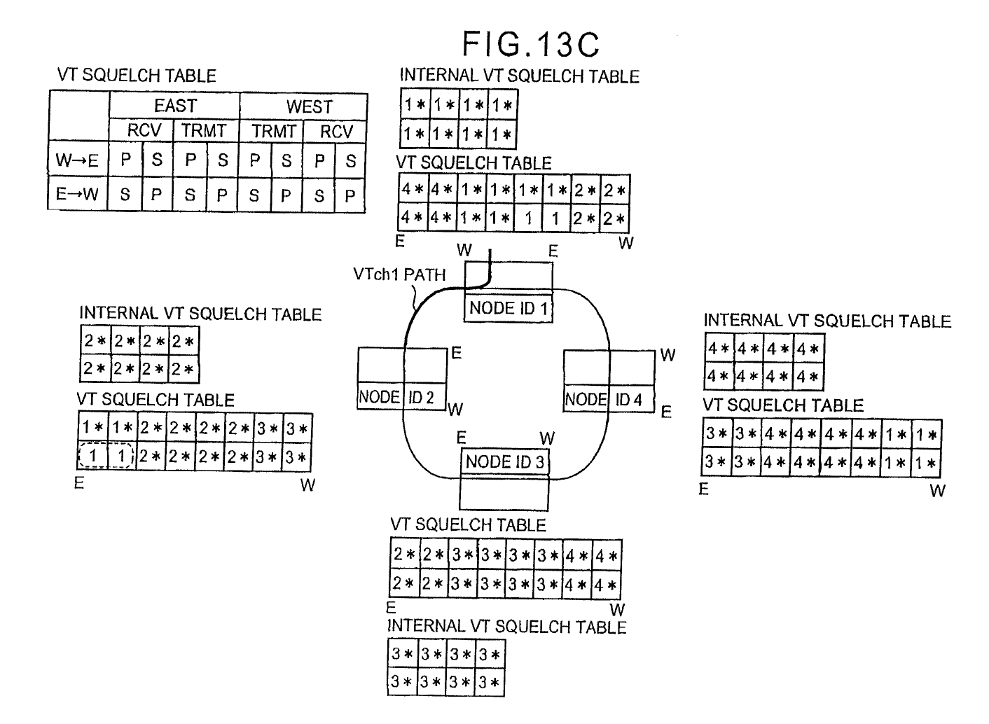

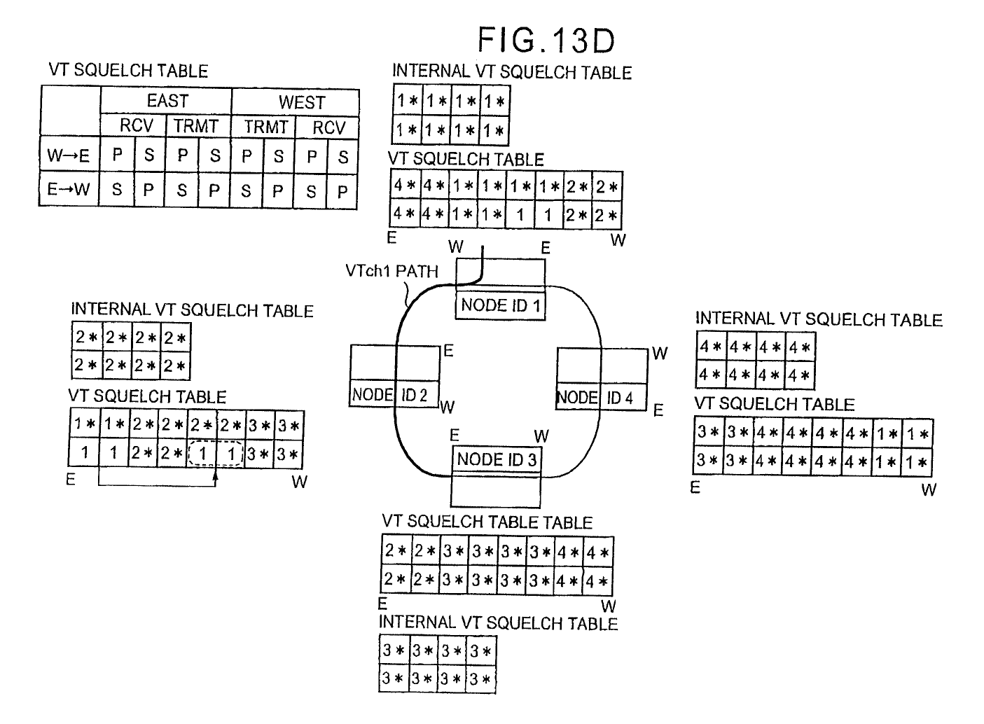

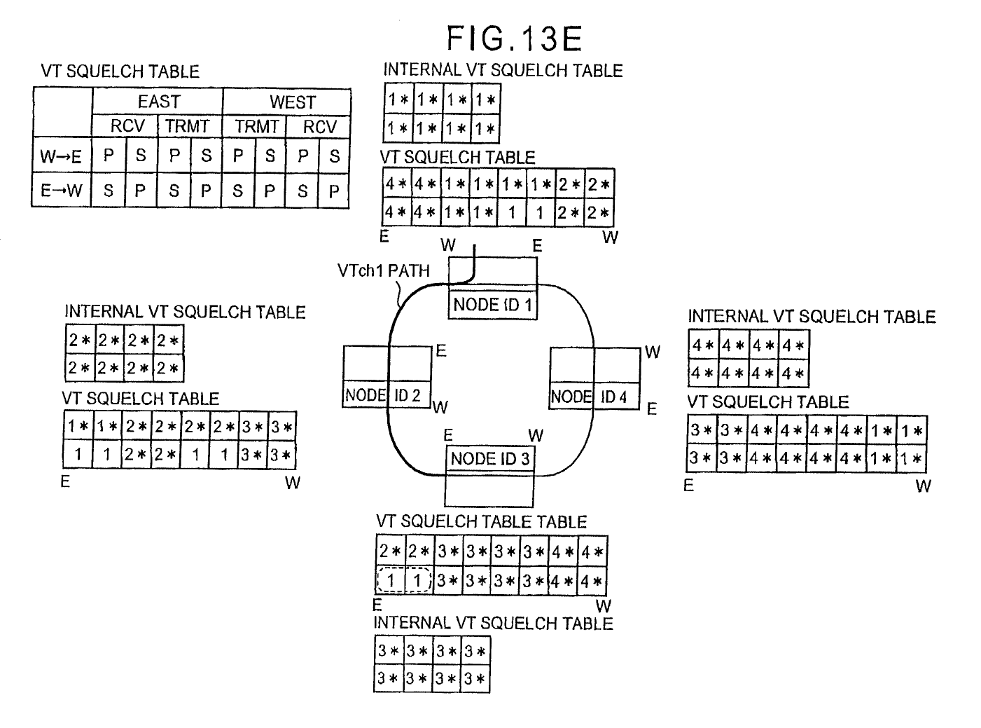

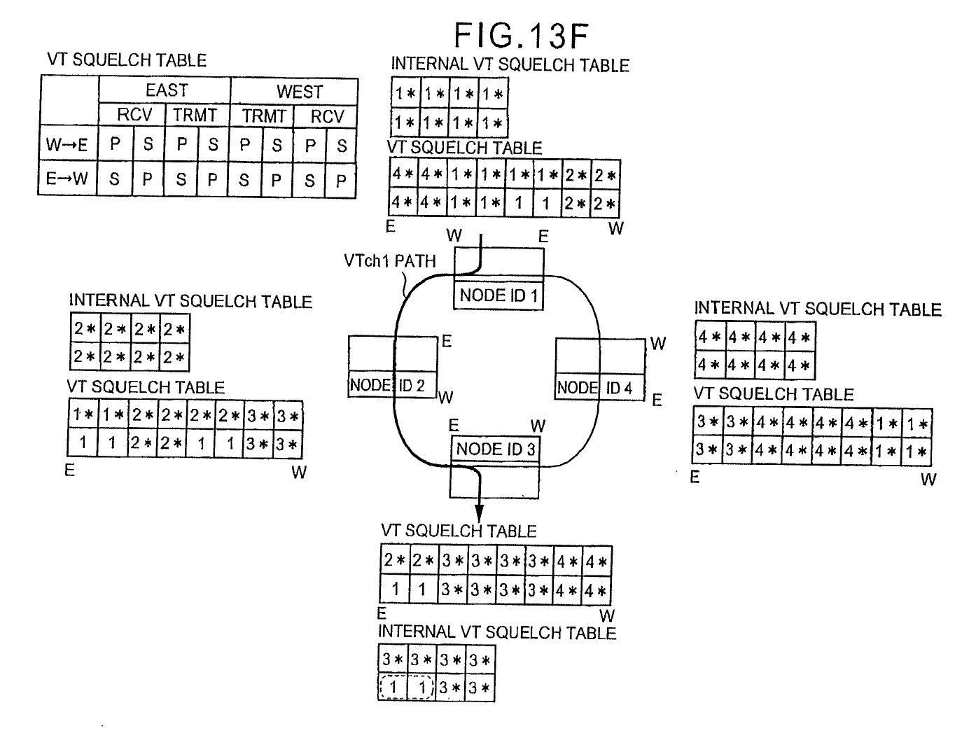

FIGS. 13A through 13F are diagrams showing a sequence of processes for creating the VT squelch table in a passing-through operation in a case that the VTch1 is added at the node 1 and is dropped at the node 3 in a BLSR according to the third embodiment of the preset invention. In the below description, a primary node ID area (P) and a secondary node ID area (S) in a TRMT area are respectively referred to as a TRMT(P) and a TRMT(S). Additionally, a primary node ID area (P) and a secondary node ID area (S) in a RCV area are respectively referred to as a RCV(P) and a RCV(S). FIG. 13A shows initial conditions of all the nodes having no cross connection settings on the BLSR. The VT squelch table of each node includes its node ID number in the TRMT areas and node ID numbers of its adjacent nodes in the RCV areas thereof. As shown in FIG. 13B, the node 1 initially adds a channel VTch1 in the E→W direction as a part of a call setting since the node 1 is an adding station. To be concrete, the node 1 inserts the node ID number “1” to the TRMT(P, S) for the E→W direction in the WEST column of the VT squelch table of the node 1 as well as transmits the TRMT(P, S)=(1, 1) for the E→W direction in the WEST column of the VT squelch table to the node 2.

The node 2 receives the TRMT(P, S)=(1, 1) from the node 1, and sets the RCV(P, S)=(1, 1) for the E→W direction in the EAST column of the VT squelch table of the node 2 as shown in FIG. 13C. Since the node 2 is a passing-through station, the node 2 passes the VTch1 through the node 2 in the E→W direction as a part of the call setting. To be concrete, the node 2 copies the values (1, 1) to the TRMT(P, S) for the E→W direction in the WEST column of the VT squelch table as shown in FIG. 13D. Subsequently, the node 2 transmits the TRMT(P, S)=(1, 1) for the E→W direction in the WEST column of the VT squelch table to the node 3. On the other hand, the node 3 receives the TRMT(P, S)=(1, 1) from the node 2, and sets the RCV(P, S)=(1, 1) for the E→W direction in the EAST column of the VT squelch table of the node 3 as shown in FIG. 13E. Since the node 3 is a dropping station, the node 3 drops the VTch1 in the E→W direction as a part of the call setting. To be concrete, the node 3 copies the values (1, 1) to the primary node ID area (P) and the secondary node ID area (S) for the E→W direction in the EAST column of the internal VT squelch table of the node 3 as shown in FIG. 13F.

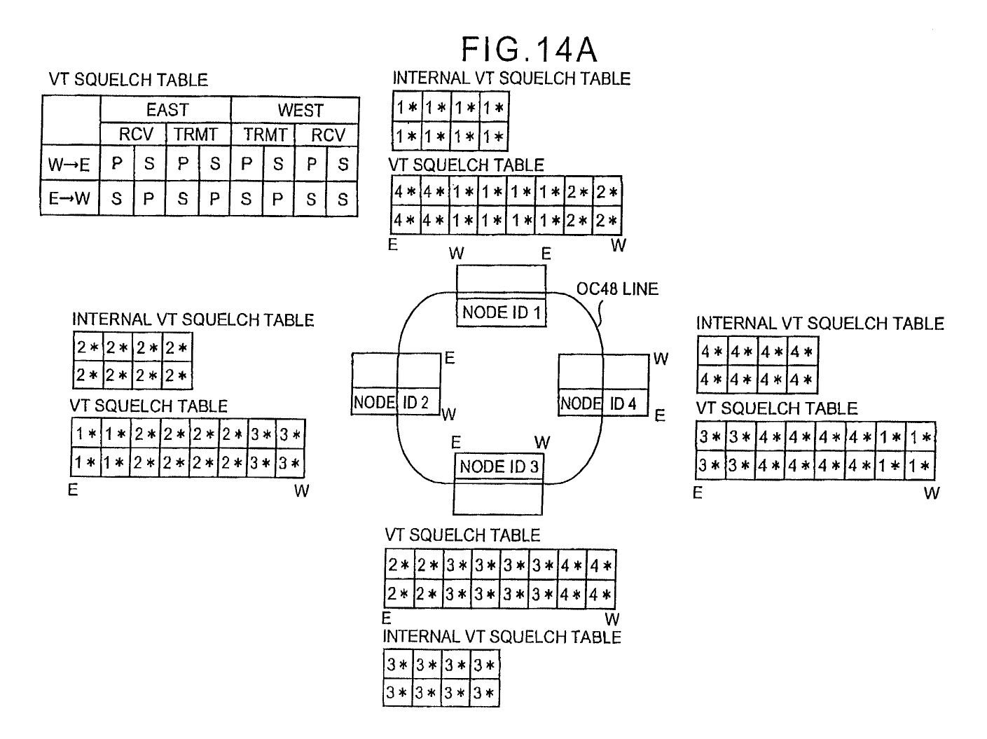

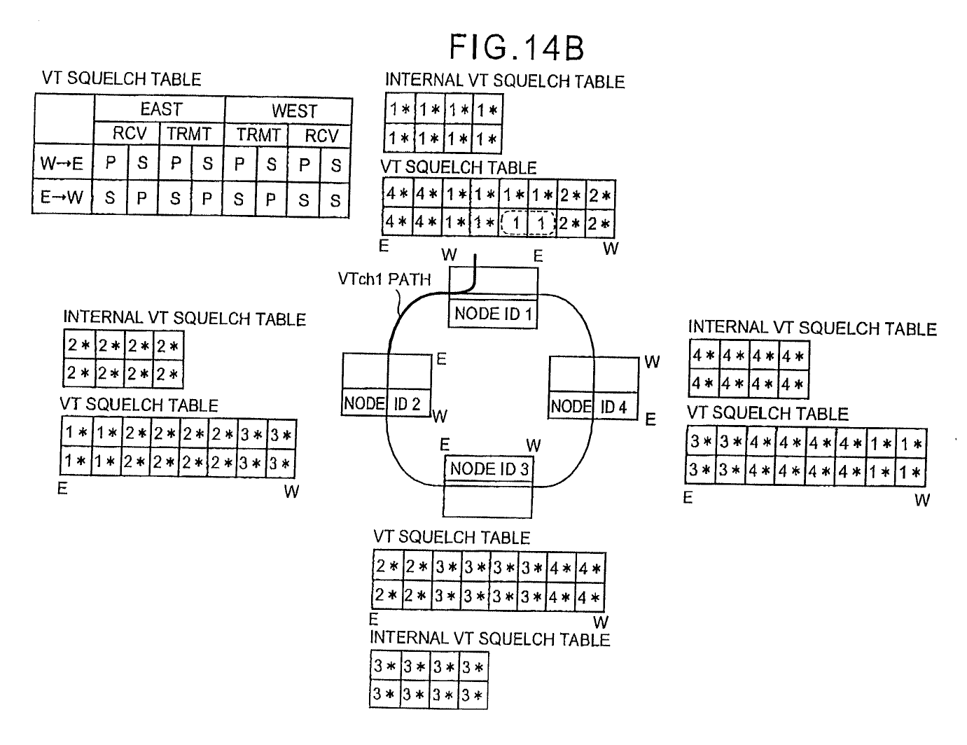

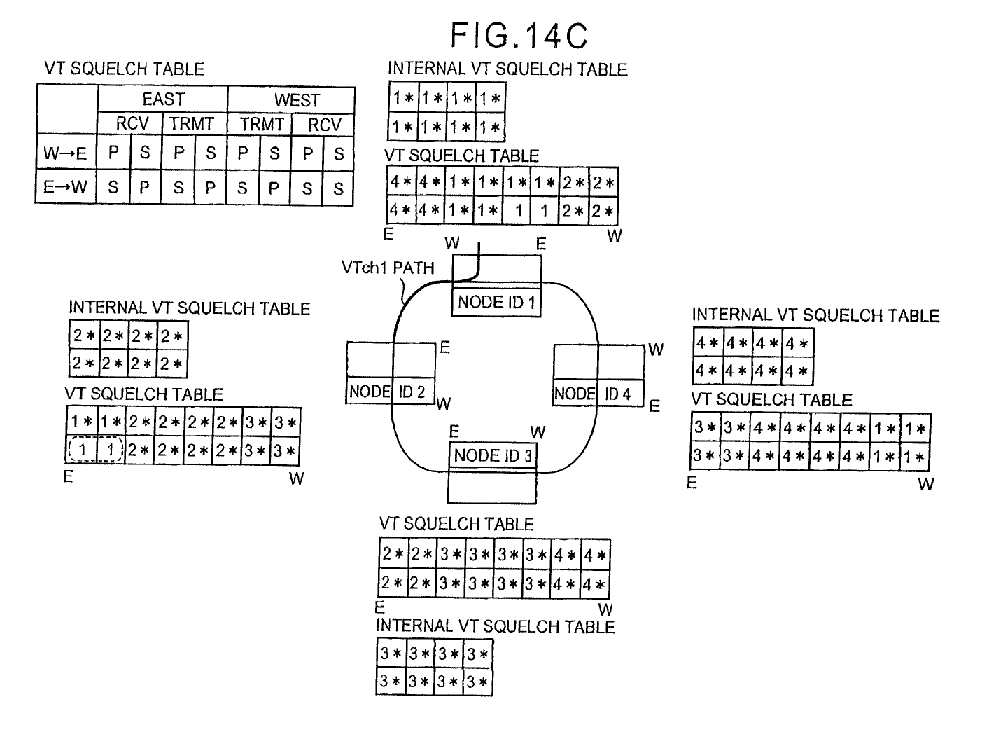

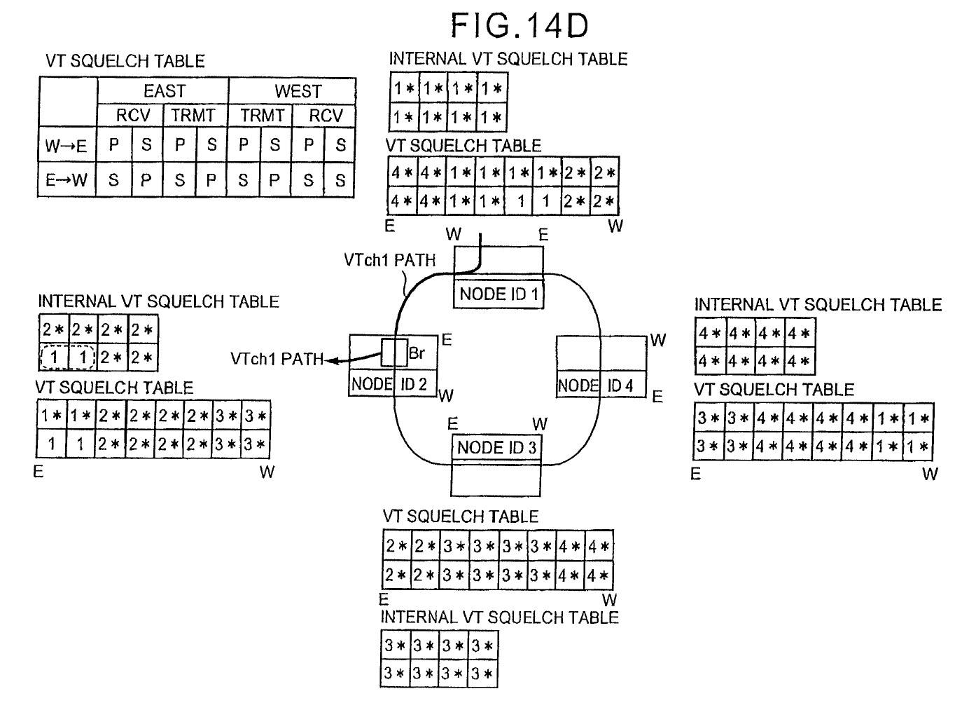

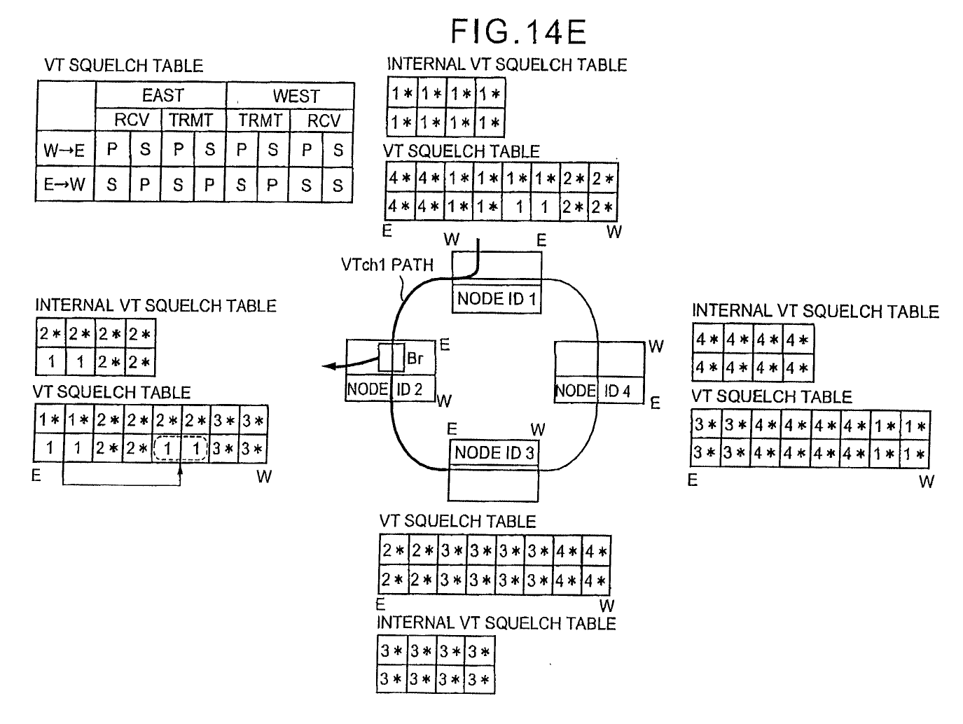

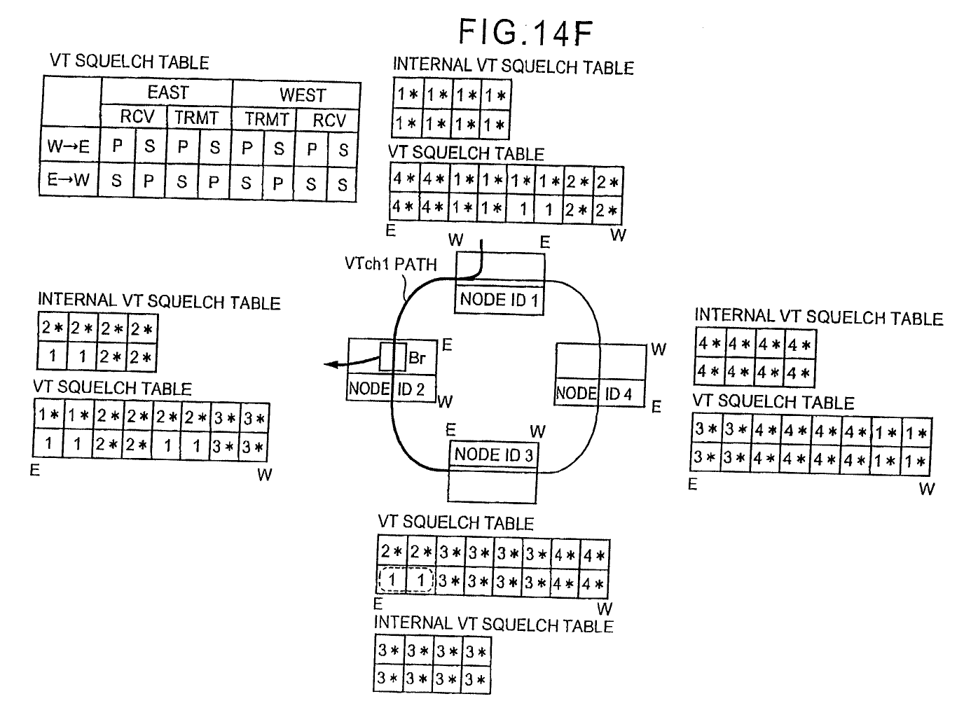

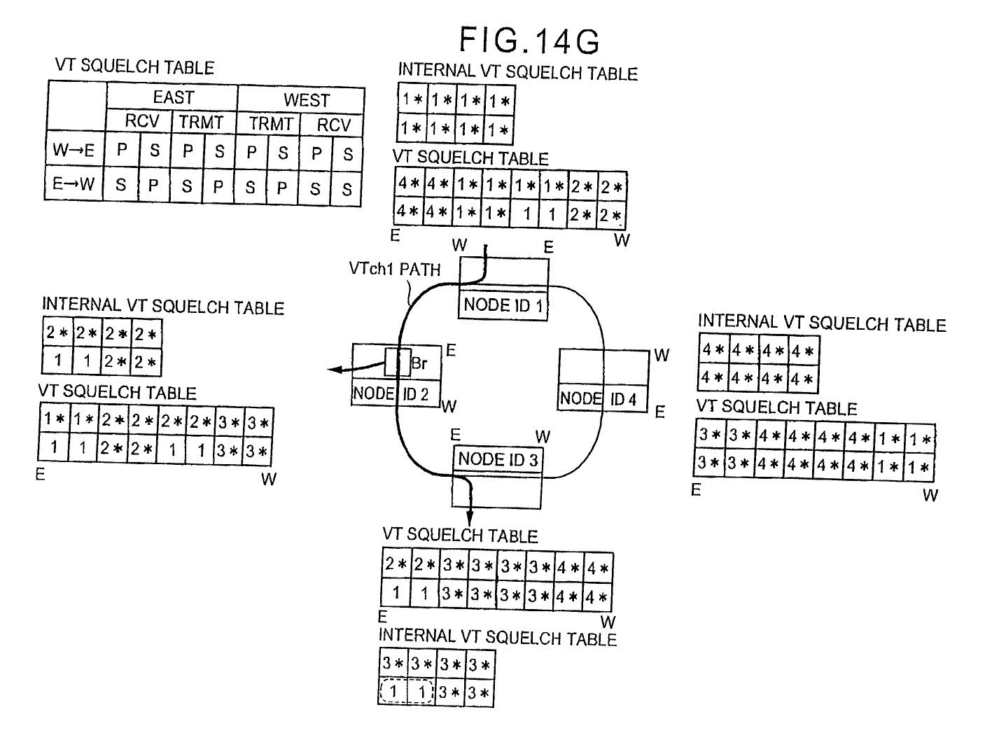

FIGS. 14A through 14G are diagrams showing a sequence of processes for creating the VT squelch table in a bridging operation according to the third embodiment of the preset invention. The sequence of processes shown in FIG. 14A through 14G corresponds to processes performed in the BLSR 1 for bridging at the node 2′ shown in FIG. 12. FIG. 14A shows initial conditions of all the nodes having no cross connection settings on the BLSR. The VT squelch table of each node includes its node ID number in the TRMT areas and node ID numbers of its adjacent nodes in the RCV areas thereof. As shown in FIG. 14B, the node 1 initially adds a channel VTch1 in the E→W direction since the node 1 is an adding station. To be concrete, the node 1 inserts the node ID number “1” to the TRMT(P; S) for the E→W direction in the WEST column of the VT squelch table of the node 1 as well as transmits the TRMT(P, S)=(1, 1) for the E→W direction in the WEST column of the VT squelch table to the node 2.

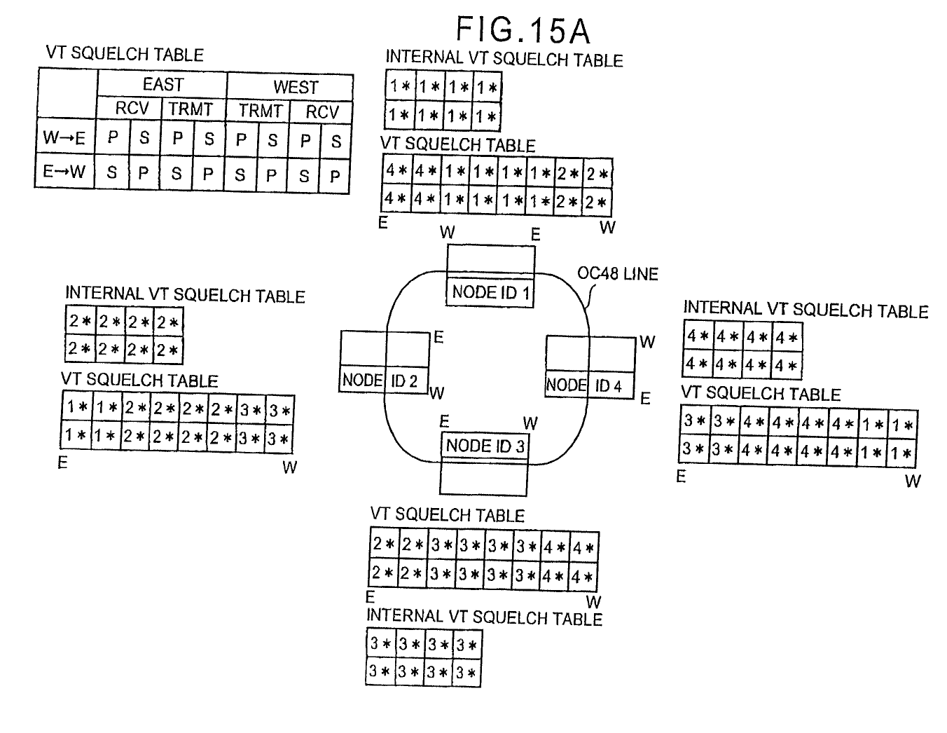

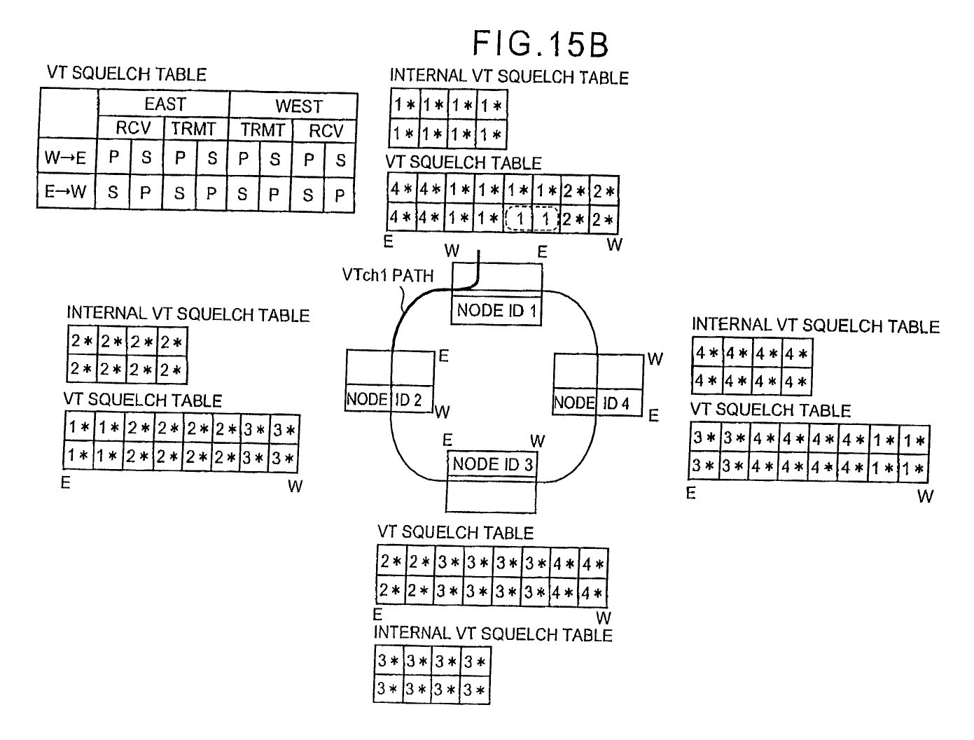

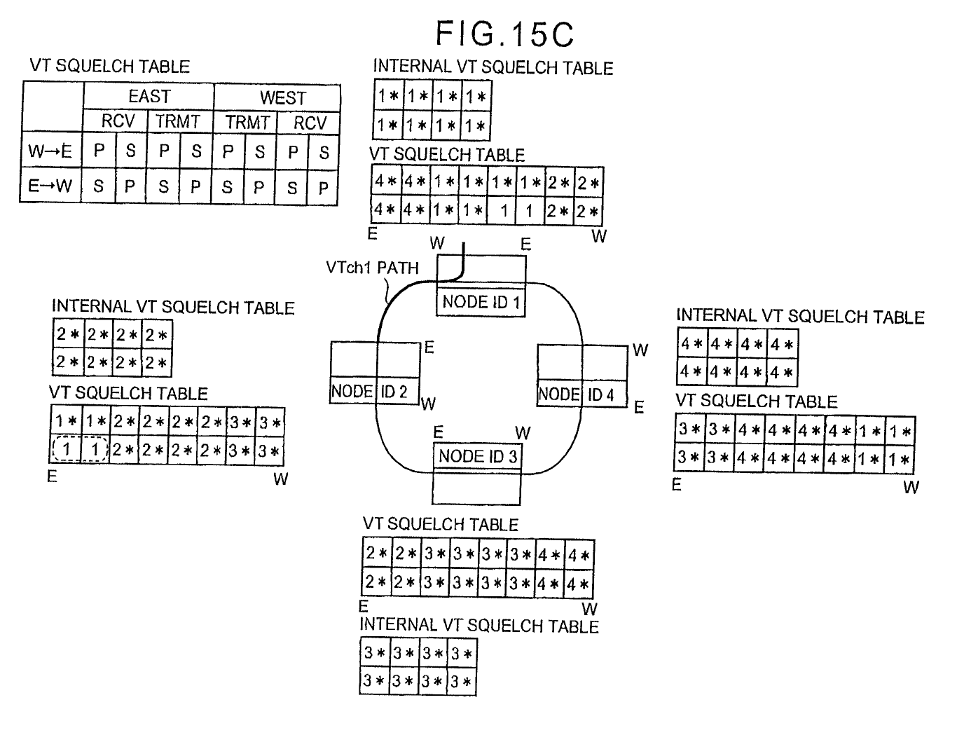

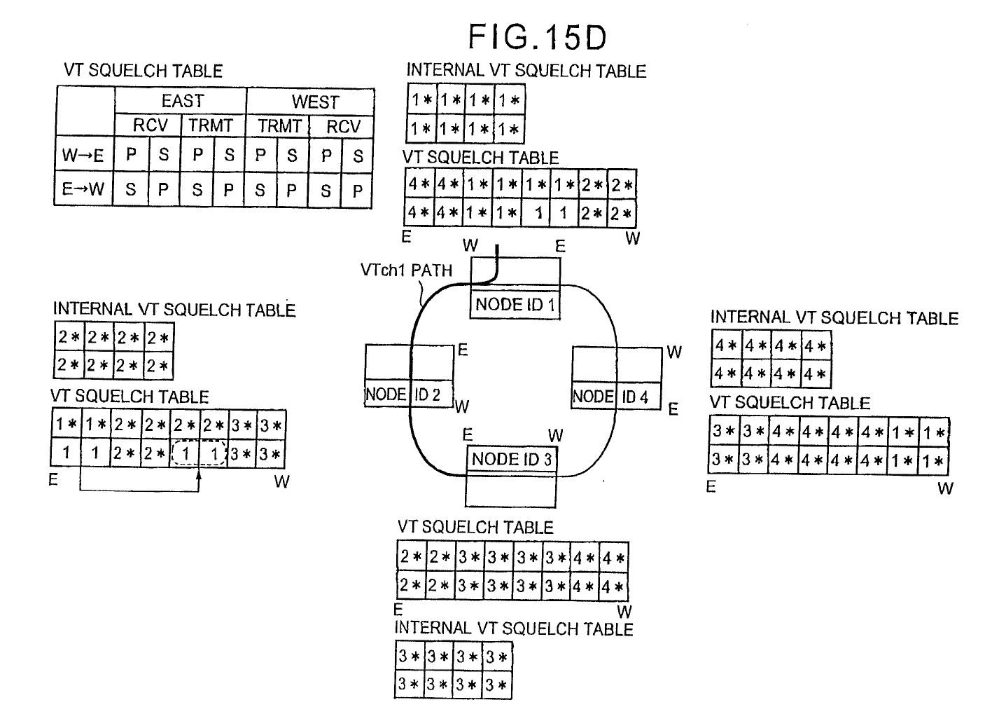

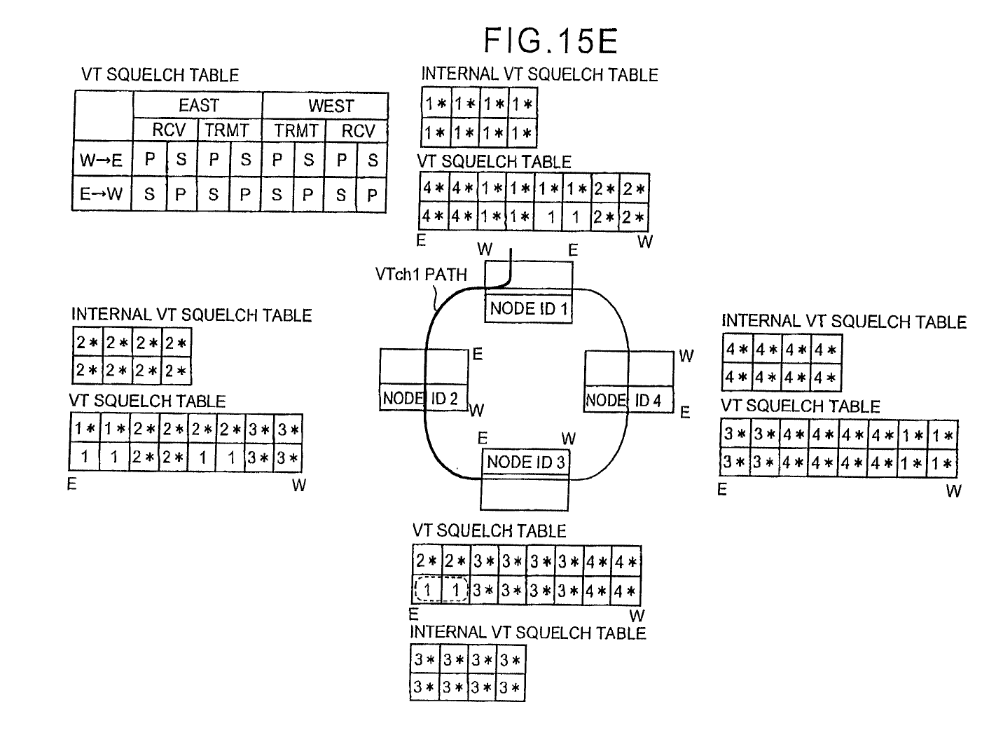

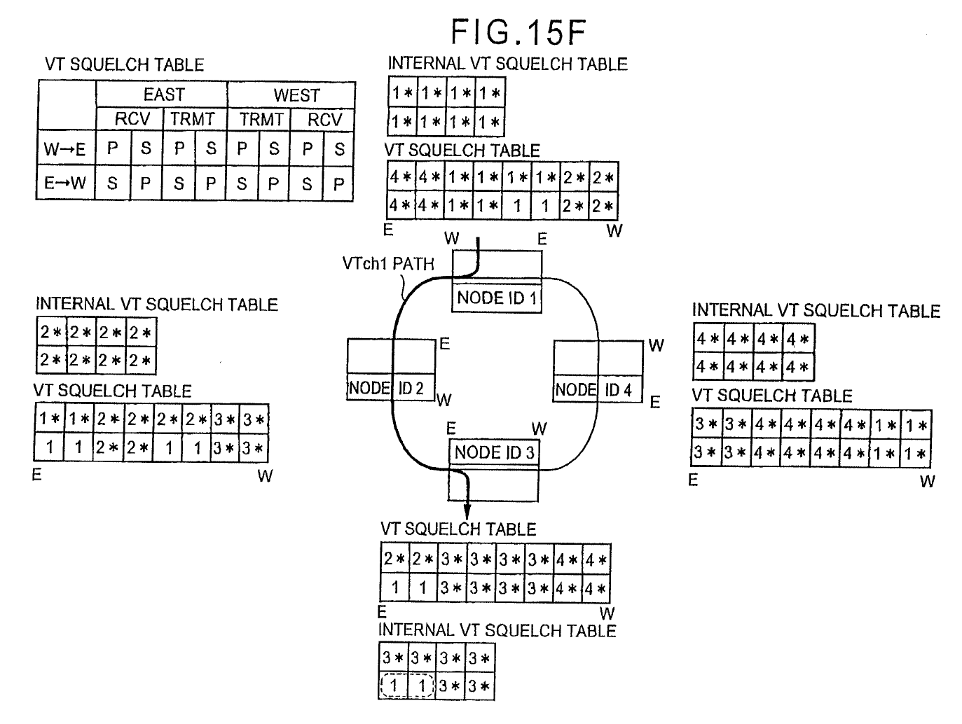

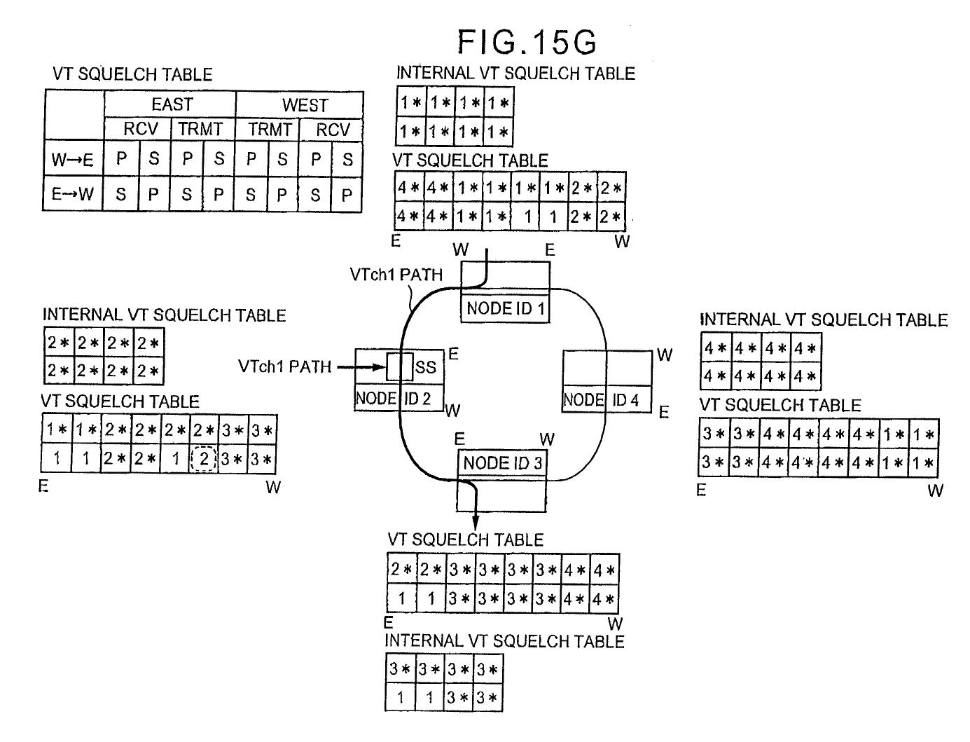

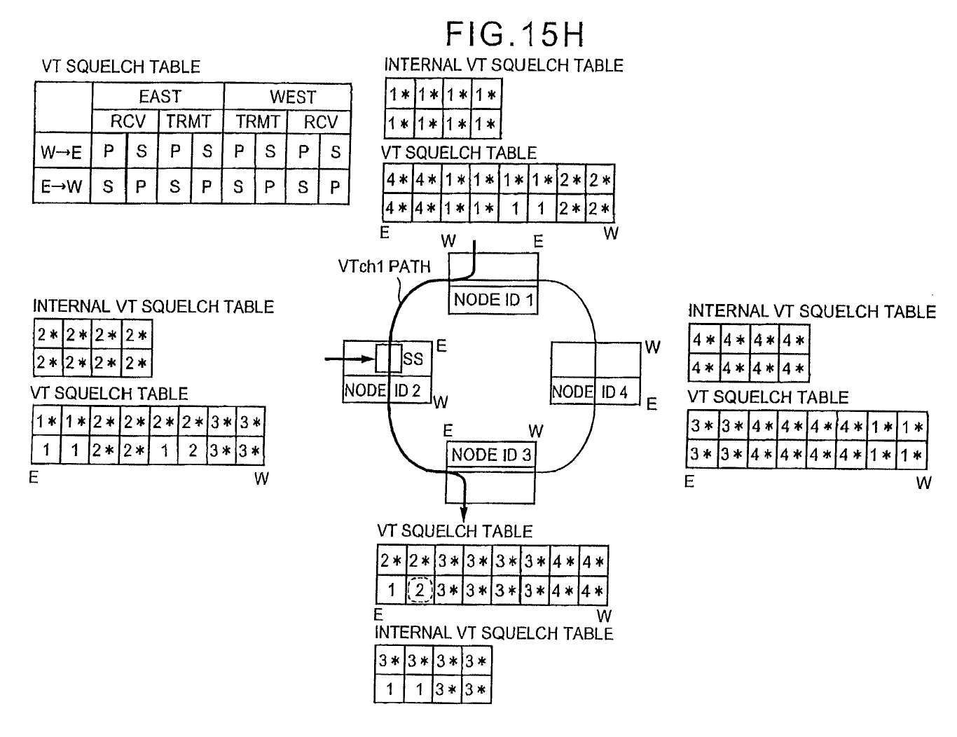

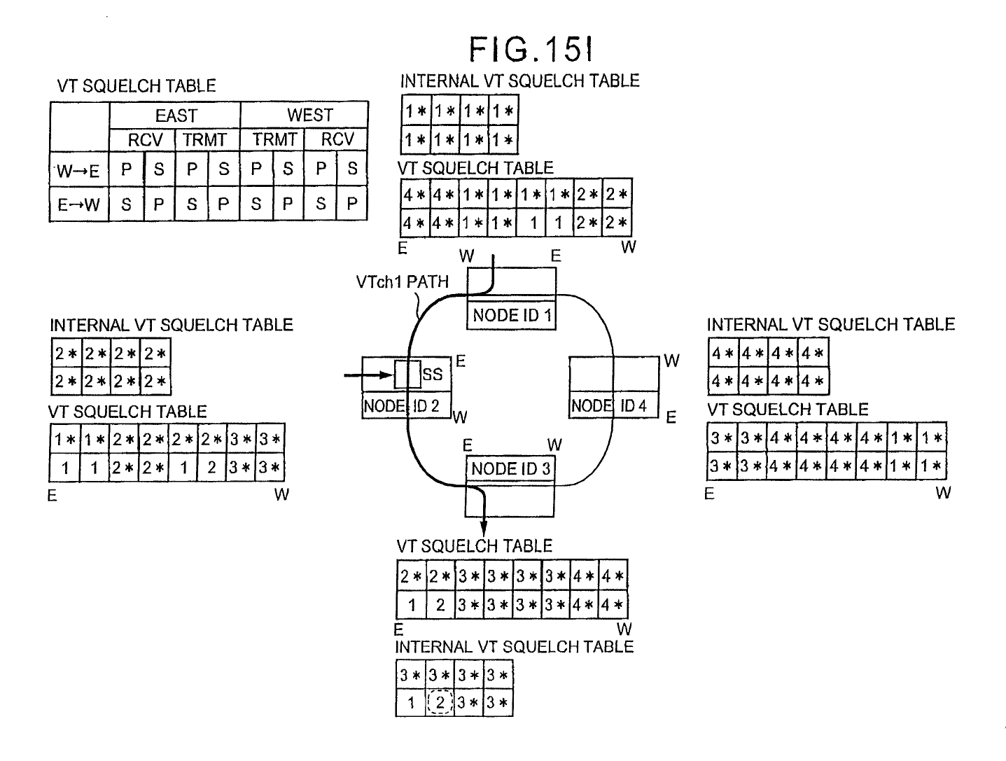

The node 2 receives the TRMT(P, S)=(1, 1) from the node 1, and sets the RCV(P, S)=(1, 1) for the E→W direction in the EAST column of the VT squelch table of the node 2 as shown in FIG. 14C. Since the node 2 is a bridging station, the node 2 drops the VTch1 in the E→W direction as well as copies the values (1, 1) to the primary node ID area (P) and the secondary node ID area (S) for the E→W direction in the EAST column of the internal VT squelch table of the node 2 as shown in FIG. 14D. Additionally, the node 2 passes the VTch1 through the node 2 in the E→W direction as well as copies the values (1, 1) to the TRMT(P, S) for the E→W direction in the WEST column of the VT squelch table as shown in FIG. 14E. Subsequently, the node 2 transmits the TRMT(P, S)=(1, 1) for the E→W direction in the WEST column of the VT squelch table to the node 3. The node 3 receives the TRMT(P, S)=(1, 1) from the node 2, and sets the RCV(P, S)=(1, 1) for the E→W direction in the EAST column of the VT squelch table of the node 3 as shown in FIG. 14F. Since the node 3 is a dropping station, the node 3 drops the VTch1 in the E→W direction as well as copies the values (1, 1) to the primary node ID area (P) and the secondary node ID area (S) for the E→W direction in the EAST column of the internal VT squelch table of the node 3 as shown in FIG. 14G, FIGS. 15A through 15I are diagrams showing a sequence of processes for creating the VT squelch table in a BLSR system including a service selector according to the third embodiment of the preset invention. The sequence of processes shown in FIG. 15A through 15I corresponds to processes performed in the BLSR 2 shown in FIG. 12. FIG. 15A shows initial conditions of all the nodes having no cross connection settings on the BLSR, The VT squelch table of each node includes its node ID number in the TRMT areas and node ID numbers of its adjacent nodes in the RCV areas thereof. As shown in FIG. 15B, the node 1 initially adds a channel VTch1 in the E→W direction since the node 1 is an adding station. To be concrete, the node 1 inserts the node ID number “1” to the TRMT(P, S) for the E→W direction in the WEST column of the VT squelch table of the node 1 as well as transmits the TRMT(P, S)=(1, 1) for the E→W direction in the WEST column of the VT squelch table to the node 2.

The node 2 receives the TRMT(P, S);-(1, 1) from the node 1, and sets the RCV(P, S)=(1, 1) for the E→W direction in the EAST column of the VT squelch table of the node 2 as shown in FIG. 15C Since the node 2 is a passing-through station, the node 2 passes the VTch1 through the node 2 in the E→W direction as well as copies the values (1, 1) to the TRMT(P, S) for the E→W direction in the WEST column of the VT squelch table as shown in FIG. 15D. Subsequently, the node 2 transmits the TRMT(P, S)=(1, 1) for the E→W direction in the WEST column of the VT squelch table to the node 3. The node 3 receives the TRMT(P, S)=(1, 1) from the node 2, and sets the RCV(P, S)=(1, 1) for the E→W direction in the EAST column of the VT squelch table of the node 3 as shown in FIG. 15E. Since the node 3 is a dropping station, the node 3 drops the VTch1 in the E→W direction as well as copies the values (1, 1) to the primary node ID area (P) and the secondary node ID area (S) for the E→W direction in the EAST column of the internal VT squelch table of the node 3 as shown in FIG. 15F.

Additionally, after becoming a service selector SS following a call setting, the node 2 adds the VTch1 in the E→W direction as well as sets the TRMT(P)=(2) for the E→W direction in the WEST column of the VT squelch table of the node 2 as shown in FIG. 15G. Subsequently, the node 2 transmits the TRMT(P)=(2) for the E→W direction in the WEST column of the VT squelch table to the node 3. The node 3 receives the TRMT(P)=(2) from the node 2, and sets the RCV(P)=(2) for the E→W direction in the EAST column of the VT squelch table of the node 3 as shown in FIG. 15H. Since the node 3 is the dropping station, the node 3 copies the value (2) to the primary node ID area (P) for the E→W direction in the EAST column of the internal VT squelch table of the node 3 as shown in FIG. 15I.

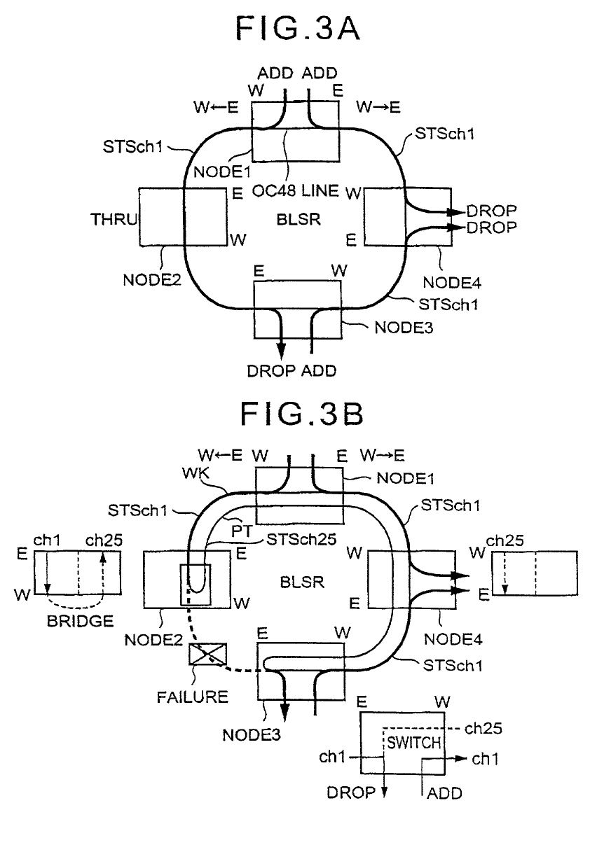

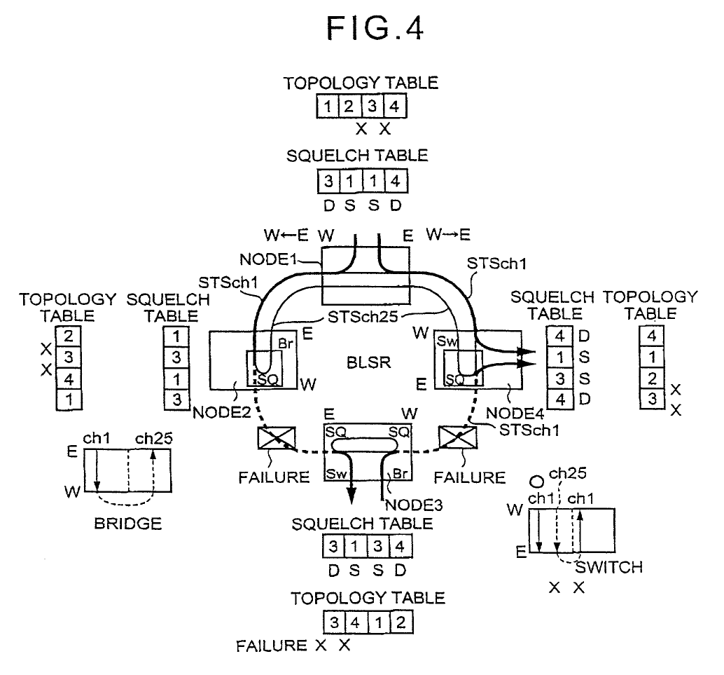

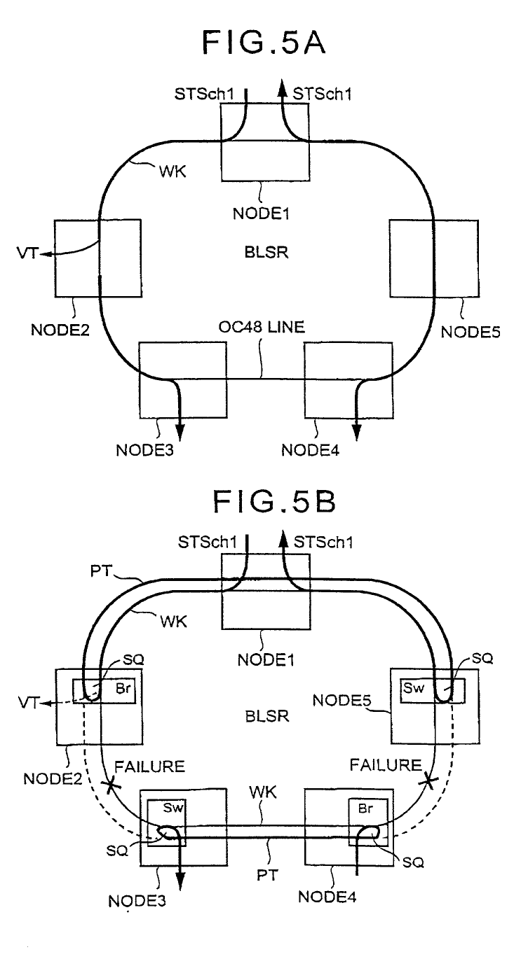

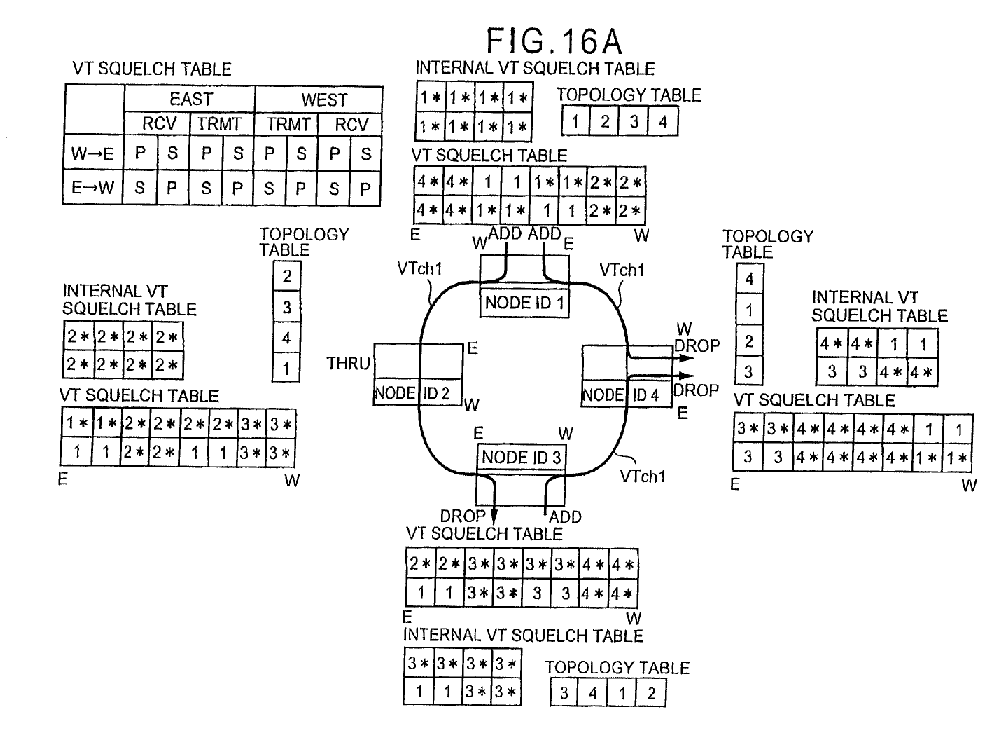

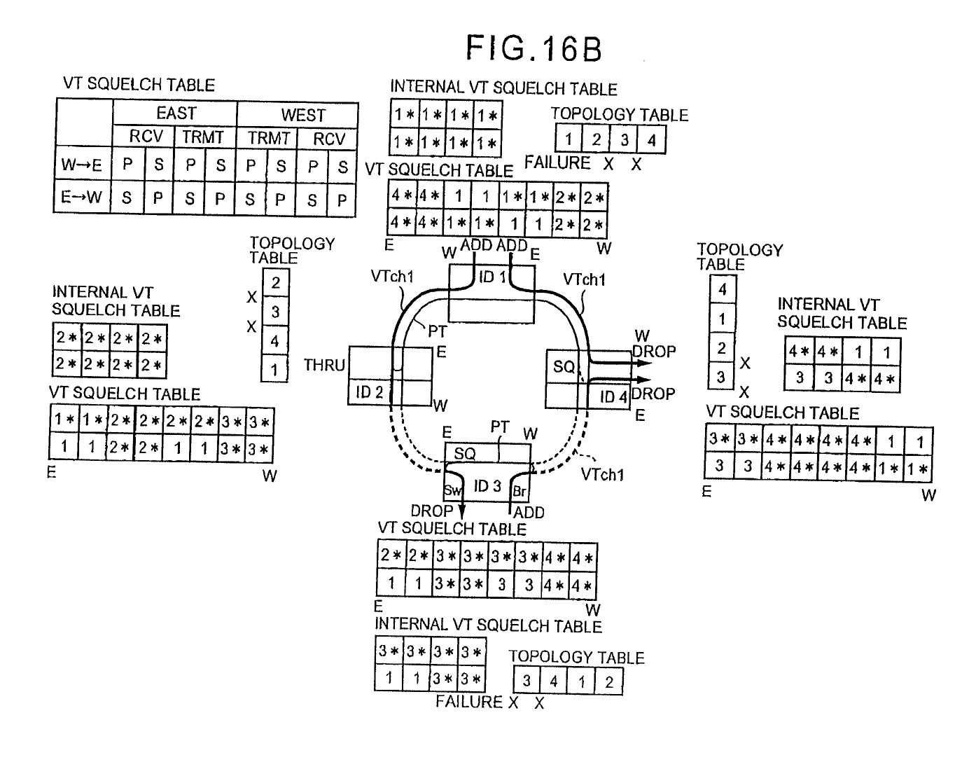

FIGS. 16A and 16B are diagrams showing a VT-access BLSR squelch control method according to a fourth embodiment of the present invention. FIG. 16A shows a condition of a BLSR when line failure has not occurred on a ring of the BLSR yet. In FIG. 16A, a channel VTch1 is set from the node 1 to the node 3, from the node 1 to the node 4, and from the node 3 to the node 4 similarly to FIG. 3A. The nodes 1 through 4 are respectively an adding station, a passing-through station, a dropping station, and another dropping station. Each node shown in FIG. 16A includes a VT squelch table, an internal VT squelch table and a topology table. FIG. 16B shows the condition of the BLSR when the line failure has occurred in the ring of the BLSR. The line failure has occurred between the nodes 2 and 3, and between the nodes 3 and 4 as shown in FIG. 16B. The node 3 as the dropping station of a VTch1 path from the node 1 to the node 3 can determine that a signal from the node 1 does not reach the node 3 based on the fact that both of paths from the node 1 in the E→W and W→E directions to the node 3 are failed, by referencing the topology table of the node 3 by use of the fact that the node 1 is the adding station of the VTch1 path and line failure information. Accordingly, the node 3 inserts a VT squelch to the VTch1.

The node 4 as the dropping station of the VTch1 path from the node 1 to the node 4 detects a valid path between the node 1 and the node 4 by referencing the fact that the node 1 is the adding station of the VTch1 path and the line failure information, and thus can determine that a signal from the node 1 reaches the node 4. Accordingly, the node 4 does not insert a VT squelch to the VTch1 in the W→E direction. Additionally, the node 4 as the dropping station of the VTch1 path from the node 3 to the node 4 detects that the paths between the node 3 and the node 4 are failed in both E→W and W→E directions by referencing the topology table of the node 4 by use of the fact that the node 3 is the adding station of the VTch1 path and the line failure information, and thus can determine that a signal from the node 3 does not reach the node 4. Accordingly, the node 4 as the dropping station inserts a squelch to the VTch1 in the E→W direction.

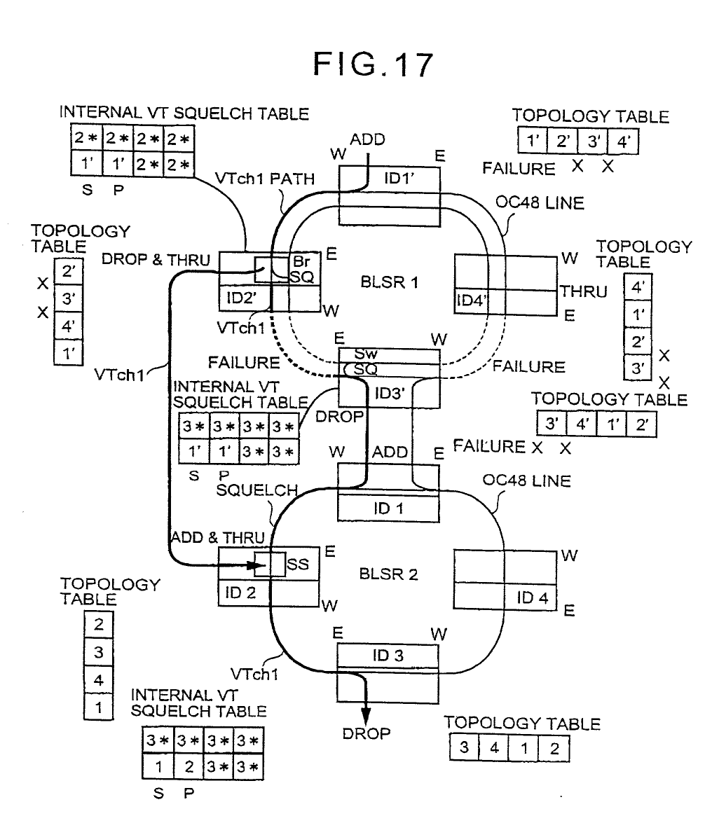

FIG. 17 is a diagram showing the VT-access BLSR squelch control method applied to a BLSR configuration in which two BLSR systems are interconnected according to a fifth embodiment of the present invention. The node 2′ as the dropping station of a VTch1 path between the nodes 1′ and 2′ does not insert a VT squelch to the channel VTch1 dropped at the node 2′ since the VTch1 path between the nodes 1′ and 2′ is valid. The node 3′ as the dropping station of a VTch1 path between the nodes 1′ and 3′ inserts a VT squelch to the channel VTch1 dropped at the node 3′ since the VTch1 path between the nodes 1′ and 3′ is failed or disconnected. Additionally, in such case, the node 2 as the service selector SS adds the VTch1 separated at the node 2′, and selects the VTch1 from the node 2′ since the VT squelch is inserted to the VTch1 in the E→W direction at the node 3′. Additionally, the node 3 does not insert a VT squelch to the VTch1 dropped at the node 3 since the VTch1 path from a source station such as the node 2 as a primary node or the node 3 as a secondary node is valid. As described above, communication through the VTch1 path between the nodes 1′ and 3 can be continued.

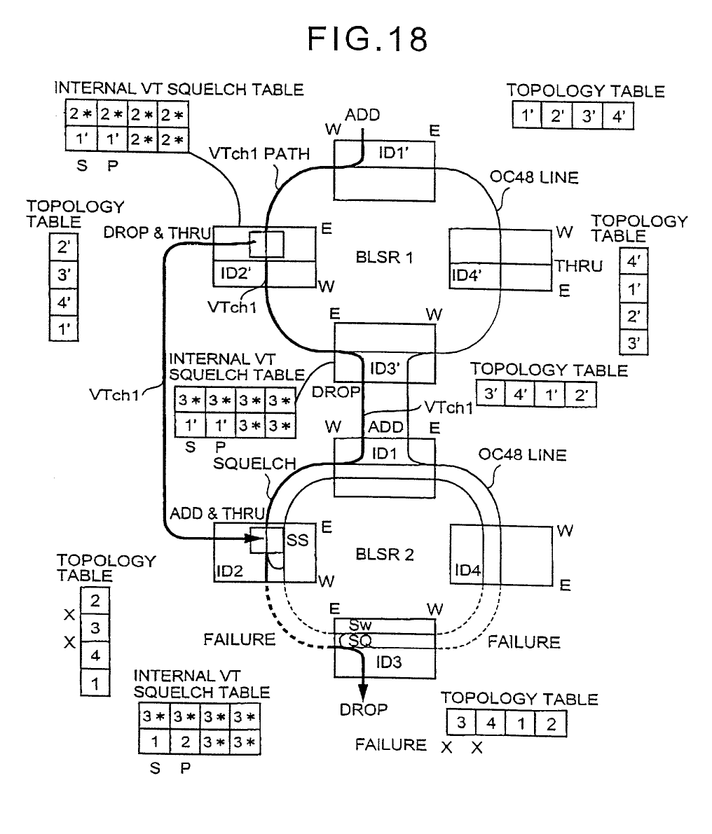

FIG. 18 is a diagram showing the VT-access BLSR squelch control method applied to another BLSR configuration in which two BLSR systems are interconnected according to the fifth embodiment of the present invention. As shown in FIG. 18, the node 3 as the dropping station inserts a VT squelch to the VTch1 dropped at the node 3 since signals from the node 2 as the primary node and the node 1 as the secondary node do not reach the node 3, in such case, the communication through the VTch1 path between the nodes 1′ and 3 cannot be continued. Additionally, the above-described VT-access BLSR squelch control method can control insertion of VT squelches appropriately for other cases with various line failure not shown in figures.

It is obvious that the above-described VT1-level squelch control method including such as creation of a squelch table and insertion of a squelch may be directly applied to an STS1-level squelch control method. Accordingly, the STS1-level squelch control method can be significantly simplified. The STS1-level squelch control method determines insertion of an STS1 squelch and inserts the STS1 squelch to an STS1 channel similarly to the conventional method at bridging and switching stations for a case in which line failure occurs on the ring of the BLSR, by using the STS squelch table that is created by the method of creating the STS squelch table shown in FIGS. 7 through 9N and includes information about source and destination nodes. Additionally, the STS1-level squelch control method may stop determining insertion of the STS1 squelch and inserting the STS1 squelch to the STS1 channel, instead, may determine insertion of a VT squelch and insert the VT squelch to a VT channel at a dropping station where the VT1 channel diverges from the STS1 channel even if the dropping station corresponds to the bridging or switching station for the case in which the line failure occurs on the ring of the BLSR.

The description has been given of the squelch control method applied to the STS1-level and VT1-level lines. However, it is obvious that the squelch control method according to the present invention may be applied to lines of various types and levels.

As described above, according to the present invention, misconnection for a large number of VT1-level lines can be efficiently prevented. Additionally, processing load on a single node can be decreased by executing squelch control processes efficiently by each dropping station, the squelch control processes being executed intensely by a switching station used for a case in which line failure occurs on a ring of a BLSR in a conventional squelch control method. Accordingly, the present invention eliminates performance problems of each node apparatus on the ring of the BLSR, thereby contributing to increase in reliability of a ring transmission system.

The above description is provided in order to enable any person skilled in the art to make and use the invention and sets forth the best mode contemplated by the inventors of carrying out the invention.

The present invention is not limited to the specially disclosed embodiments and variations, and modifications may be made without departing from the scope and spirit of the invention.

The present application is based on Japanese Priority Application No. 11-367451, filed on Dec. 24, 1999, the entire contents of which are hereby incorporated by reference.

What is claimed is:

1. A ring transmission system in which a plurality of nodes are connected to each other to form a ring by a bi-directional line switched ring (BLSR) method, said ring transmission system comprising:
a channel-adding node that adds a channel to the ring, and transmits a node identification (ID) of said channel-adding node to other nodes on the ring when creating a squelch table; and
a channel-dropping node that drops the channel from the ring, and stores the node ID of said channel-adding node received directly from said channel-adding node or through the other nodes on the ring in the squelch table of said channel-dropping node,
wherein said channel-dropping node detects a failed channel through which a signal does not reach said channel-dropping node among one or more channels dropped at said channel-dropping node based on information about a location of failure on the ring, a ring-topology table managed by said channel-dropping node, and the node ID of said channel-adding node stored in the squelch table of said channel-dropping node when the failure occurs on the ring, and inserts a squelch into the failed channel.

2. The ring transmission system as claimed in claim 1, further comprising a channel dropping/passing-through node that drops the channel from the ring as well as passes the channel to the other nodes on the ring, said channel dropping/passing-through node storing the node ID of said channel-adding node received from said channel-adding node in the squelch table of said channel dropping/passing-through node as well as transmitting the node ID of said channel-adding node to the other nodes on the ring,
wherein said channel dropping/passing-through node detects the failed channel through which the signal does not reach said channel dropping/passing-through node among one or more of the channels dropped at said channel dropping/passing-through node based on the information about the location of the failure on the ring, the ring-topology table managed by said channel dropping/passing-through node, and the node ID of said channel-adding node stored in the squelch table of said channel dropping/passing-through node when the failure occurs on the ring, and inserts the squelch into the failed channel.

3. The ring transmission system as claimed in claim 1, further comprising a service selector node that adds a first channel from outside the ring to a second channel on the ring, and can select one of first and second channels according to communication status of the first and second channels as well as transmits the node ID of said service selector node to the other nodes on the ring when creating the squelch table,
wherein said channel-dropping node detects the failed channel through which the signal does not reach said channel-dropping node among one or more of the channels dropped at said channel-dropping node based on the information about the location of the failure on the ring, the ring-topology table managed by said channel-dropping node, and the node ID of said channel-adding node and of said service selector node in the squelch table of said channel-dropping node when the failure occurs on the ring, and inserts the squelch into the failed channel.

4. The ring transmission system as claimed in claim 3, further comprising a channel dropping/passing-through node that drops the channel from the ring as well as passes the channel to the other nodes on the ring, said dropping/passing-through node storing the node ID of said channel-adding node received from said channel-adding node in the squelch table of said channel dropping/passing-through node as well as transmitting the node ID of said channel-adding node to the other nodes on the ring,
wherein said channel dropping/passing-through node detects the failed channel through which the signal does not reach said channel dropping/passing-through node among one or more of the channels dropped at said channel dropping/passing-through node based on the information about the location of the failure on the ring, the ring-topology table managed by said channel dropping/passing-through node, and the node ID of said channel-adding node and of said service selector node stored in the squelch table of said channel dropping/passing-through node when the failure occurs on the ring, and inserts the squelch into the failed channel.

5. The ring transmission system as claimed in claim 1, further comprising a channel passing-through node that passes the channel and the node ID of said channel-adding node received from said channel-adding node though said channel passing-through node to said channel-dropping node.

6. The ring transmission system as claimed in claim 1, wherein the channel corresponds at least one of STS1 and VT1 accesses.

7. The ring transmission system as claimed in claim 1, wherein said ring transmission system includes a plurality of bi-directional line switched rings including a plurality of nodes, said bi-directional switched rings being connected to each other through the nodes.

8. A method of controlling a squelch in a ring transmission system in which a plurality of nodes are connected to each other to form a ring by a bi-directional line switched ring (BLSR) method, said method comprising the steps of:
adding a channel at channel-adding node on the ring;
transmitting node ID of said channel-adding node to other nodes on the ring;
receiving the node ID of said channel-adding node at a channel-dropping node;
storing the node ID of said channel-adding node in a squelch table of said channel-dropping node;
detecting a failed channel dropped at said channel-dropping node through which a signal does not reach said channel-dropping node based on information about a location of failure on the ring, a ring-topology table managed by said channel-dropping node, and the node ID of said channel-adding node stored in the squelch table of said channel-dropping node; and
inserting a squelch into the failed channel.

9. The method as claimed in claim 8, wherein said method is not executed on an upper-level channel at said channel-dropping node where a lower-level channel diverges from toe upper-level channel.

10. The method as claimed in claim 8, wherein said method is executed on an upper-level channel at a node where a lower-level channel does not diverge from the upper-level channel.
